(19) United States
(12) Patent Application Publication
(10) Pub. No.: US 2023/0062056 A1
(43) Pub. Date: Mar. 2, 2023

(54) WATER SUPPLY DEVICE IN CABINET

(71) Applicant: LG Electronics Inc., Seoul (KR)

(72) Inventor: Kiyoung LIM, Seoul (KR)

(21) Appl. No.: 17/791,025

(22) PCT Filed: Dec. 17, 2020
(86) PCT No.: PCT/KR2020/018552

§ 371 Date: Jul. 6, 2022

(30) Foreign Application Priority Data
Jan. 6, 2020 (KR) 10-2020-0001673

(51) Int. Cl. A01G 9/24; G01F 23/26

(52) U.S. Cl. CPC A01G 9/247; G01F 23/26

(57) ABSTRACT

A water supply apparatus in a cabinet includes an outer case defining an outer appearance, an inner case defining a first space therein, and an insulating material disposed between the inner case and the outer case. The water supply apparatus includes a water tank including a tank body configured to store water, and a tank cover configured to open and close the tank body, a tank rail provided in the inner case and configured to allow the water tank to be introduced into or withdrawn from the first space, and a water level detection device configured to be fixedly mounted on the first space, to be in contact with the tank body in a state where the water tank is introduced, and to detect a level of water stored in the tank body.

### TECHNICAL FIELD

The present disclosure relates to a water supply apparatus in a cabinet.

### BACKGROUND ART

In general, an apparatus for cultivating plants includes a predetermined cultivating chamber having an environment appropriate to grow the plants, and the plants are stored in the predetermined cultivating chamber. The apparatus for cultivating plants has components to supply nutrients and light energy required for plant growth, and the plants are grown by the supplied nutrients and light energy.

An apparatus for cultivating plants according to the related art is disclosed in Korean Patent Registration No. 10-1240375. In this related art, the water supply structure is disclosed in which a multi-stage tray is disposed inside a cabinet, light is irradiated from a light irradiation unit to the tray, and the nutrient solution is supplied to the tray through the nutrient solution recovery container, and the inside of the cabinet is set at a set temperature by the air conditioning unit and the air circulation fan to be capable of cultivating plants.

However, in the related art, a structure for replenishing the nutrient solution and water is not disclosed, and when viewed as a structure in which the flow path is connected, it can be viewed as a structure of a fixed nutrient solution recovery container, and in this case, there is a problem in that water supply management and washing are very inconvenient.

Meanwhile, in US Patent No. 2018/0359946, a structure is disclosed in which a plurality of trays for cultivating plants are provided in an inner portion of the cabinet, and light means irradiating light and water supply means are provided above the tray to supply nutrient solution, and a cooling device and a heating device using a refrigeration cycle are provided to adjust the temperature in the inner portion of the cabinet.

However, in this structure, there is a problem in that the tank for supplying the nutrient solution is disposed inside the machine room, so that it is not easy to replenish the nutrient solution or clean or manage.

In particular, when the tank is disposed inside the machine room, there is no choice but to have a water replenishment structure through a separate pipe connection, and in this case, there is a problem that the installation is limited and difficult.

### DISCLOSURE

### Technical Problem

An object of the present disclosure is to provide a water supply apparatus in a cabinet that is easy to install and is not restricted by a usage environment.

An object of the present disclosure is to provide a water supply apparatus in a cabinet capable of accurately detecting the water level of a water tank that can be introduced or withdrawn for additional water supply.

An object of the present disclosure is to provide a water supply apparatus in a cabinet that can ensure reliability of detecting the water level in a water tank.

### Technical Solution

According to the present embodiment, a water supply apparatus in a cabinet formed of an outer case forming an outer appearance, an inner case forming a first space therein, and an insulating material disposed between the inner case and the outer case is provided, the water supply apparatus in a cabinet may include a water tank including a tank body for storing water, and a tank cover including a vertical pipe extending toward the bottom of the tank body and a horizontal pipe connected to the vertical pipe and protruding more than the rear surface of the tank body and rotatably coupled to the tank body; a tank rail in which a moving rail coupled to the tank body and a fixed rail coupled to the inner case are connected to each other, and configured to allow the water tank to be introduced into or withdrawn from the first space; a pump cover configured to be installed in the inner case to form a second space and having a pipe connection portion which opens toward the water tank so that the horizontal pipe is inserted in a state where the water tank is introduced; a water pump configured to be disposed in the second space and to be connected to the pipe connection portion; a water supply flow path configured to be disposed in the first space and to be connected to the water pump; and a water level detection device configured to be mounted on the pump cover and to detect a level of water stored in the tank body.

The horizontal pipe may be separated from the pipe connection portion in a state where the water tank is withdrawn.

The horizontal pipe may be integrally formed with the tank cover and may be rotated together when the tank cover rotates.

A cover rib protruding downward may be formed on the tank cover, and the cover rib may extend so as to be inserted into the opened upper surface of the tank body in a state where the tank cover is closed.

The water level detection device may include a detection sensor configured to detect the water level in the water tank; a detection case in which the detection sensor is accommodated; and a spring configured to support the detection case from the rear and to press the detection case toward the water tank.

The detection sensor may include an upper sensor configured to detect the full water level of the water tank; and a lower sensor provided under the upper sensor and configured to detect a low water level of the water tank.

The detection sensor may be a capacitive sensor.

The detection case may be formed so that the front surface is opened, and the detection case may include a detection cover which shields the open front of the detection case and is in contact with a circumferential surface of the water tank.

A detection device accommodation portion recessed to accommodate the water level detection device may be formed on the front surface of the pump cover, and a spring supporting the water level detection device from the rear may be provided in the detection device accommodation portion.

The front surface of the water level detection device may be supported by the spring to protrude more than the front surface of the pump cover.

Guide protrusions protruding laterally may be formed on both sides of the water level detection device, and a guide groove in which the guide protrusion is accommodated and which guides the movement of the guide protrusion in the front and rear direction may be formed on an inner surface of the detection device accommodation portion facing the guide protrusion.

The circumferential surface of the water tank may be inclined toward the outside as the circumferential surface thereof extends upward from the bottom surface, and the lower end of the guide groove may extend at an inclination corresponding to the inclination of the circumferential surface of the water tank.

The pump cover may include a cover front portion on which the water level detection device is mounted; and a cover upper surface portion extending rearward from the upper end of the cover front portion.

A tank switch to detect the introduction of the water tank by being in contact with a circumferential surface of the water tank when the introduction of the water tank is completed may be provided on the front portion of the cover.

The tank rail may include a closing module forcing an operation of the tank rail in an introduction direction of the water tank, and a contact state between the water tank and the water level detection device may be maintained by the closing module.

### Advantageous Effect

The water supply apparatus provided in the cabinet according to an embodiment of the present disclosure can expect the following effects.

According to an embodiment of the present disclosure, an openable and closable water tank is provided inside the cultivation space so that the user can additionally supply water. Since a separate line for supplying water to the water tank is not required, there is an advantage that the water tank can be easily installed anywhere a user wants.

In particular, the water tank has a structure that can be introduced or withdrawn from the cultivation space, so that a user can withdraw the water tank and then fill the water tank with water when water supply is needed. Accordingly, there is an advantage that not only the convenience of use is improved, but also the water tank can be installed anywhere without restriction of a place for water supply.

In addition, a water level detection device for detecting the water level of the water tank is provided to detect the water level of the water tank at all times, and when the water level is low, it is possible to guide the user to replenish water, so that while using a water supply type water tank, there is an advantage in that it is possible to effectively supply water necessary for the cultivation of crops.

In particular, although the water tank has a structure that can be introduced or withdrawn, the water tank is configured to detect the water level without direct contact with water from the outside of the water tank without disposing a configuration for detecting the water level in the water tank itself. Accordingly, the configuration of the water tank can be simplified, and an additional structure for waterproofing is not required, thereby improving productivity and improving stability.

In addition, by allowing the water level detection device to be in close contact with the circumferential surface of the water tank in a state where the water tank is introduced, the effect of further improving the water level detection reliability of the water tank can be expected.

In addition, in the case of the water tank, even if the shape of the circumference of the side wall surface is inclined during manufacture, the guide groove for guiding the movement of the water level detection device has a corresponding inclination, thereby ensuring close contact between the circumferential surface of the water tank and the water level detection device, and thus there is an advantage in that reliability of water level detection of the water tank can be ensured.

Tank rails for introduction or withdrawal of the water tank may be provided on both sides of the water tank, and a closing module for forcing an operation of the tank rail in a direction in which the water tank is introduced may be provided on the tank rail.

Therefore, it is prevented that the water tank is not completely introduced due to the user's negligence not to normally supply the water inside the water tank, and there is an advantage in that the water tank can be maintained in a fully introduced state to ensure reliable water supply.

In particular, when the water tank has a structure in which a pipe inside the water tank and a pipe connected to a pump disposed outside the water tank are connected to each other while the water tank is introduced or withdrawn, the case where the water tank is not completely introduced while the flow paths are connected to each other may be generated, but, the operation of the closing module enables the water tank to maintain a fully introduced state, thereby improving the reliability of the operation.

In addition, there is an advantage in that the water level detection device is in close contact with the circumferential surface of the water tank by pressing the water tank in the introduction direction by the closing module to more accurately detect the water level of the water tank.

### DESCRIPTION OF DRAWINGS

FIG. 1 is a perspective view illustrating an apparatus for cultivating plants to which a water supply apparatus according to an embodiment of the present disclosure is applied.

FIG. 2 is a perspective view illustrating a state where a door of the apparatus for cultivating plants is opened.

FIG. 3 is an exploded perspective view illustrating the apparatus for cultivating plants.

FIG. 4 is a cutaway perspective view taken along line 4-4′ of FIG. 2.

FIG. 5 is a longitudinal cross-sectional view illustrating the cabinet.

FIG. 6 is a perspective view illustrating the internal structure of a machine room of the apparatus for cultivating plants.

FIG. 7 is an exploded perspective view illustrating a blower assembly of the apparatus for cultivating plants viewed from the front.

FIG. 8 is an exploded perspective view illustrating the blower assembly viewed from the rear.

FIG. 9 is an enlarged view illustrating part “A” of FIG. 4.

FIG. 10 is an exploded perspective view illustrating the light assembly of the apparatus for cultivating plants.

FIG. 11 is a perspective view illustrating a light case of the light assembly.

FIG. 12 is a cutaway perspective view illustrating the light case.

FIG. 13 is a perspective view illustrating a water supply module of the apparatus for cultivating plants.

FIG. 14 is an exploded perspective view illustrating the water supply module.

FIG. 15 is a perspective view illustrating a state where a water tank constituting the water supply module is opened.

FIG. 16 is an exploded perspective view illustrating a pump cover constituting the water supply module.

FIG. 17 is a cross-sectional view taken along line 17-17′ of FIG. 13.

FIG. 18 is a cross-sectional view illustrating a state of the water level detection device in a state where the water tank is withdrawn.

FIG. 19 is a cross-sectional view illustrating a state of the water level detection device in a state where the water tank and the water level detection device start to come into contact.

FIG. 20 is a cross-sectional view illustrating a state of the water level detection device in a state where the water tank is completely introduced.

FIG. 21 is a rear view illustrating the pump cover.

FIG. 22 is a perspective view illustrating a state where the water supply flow path is fixed.

FIG. 23 is an enlarged view illustrating part “B” of FIG. 5.

FIG. 24 is a perspective view illustrating a state where the bed of the apparatus for cultivating plants is withdrawn.

FIG. 25 is a plan view illustrating the bed.

FIG. 26 is a cut-away perspective view illustrating the bed.

FIG. 27 is a perspective view illustrating a state where the water tank is withdrawn.

FIG. 28 is a perspective view illustrating a water supply state of the bed.

FIG. 29 is a cross-sectional view illustrating a pod seated on the apparatus for cultivating plants.

FIG. 30 is an enlarged view illustrating part “C” of FIG. 4.

### BEST MODE

Hereinafter, specific embodiments of the present disclosure will be described in detail with drawings. However, the present disclosure cannot be said to be limited to the embodiments in which the spirit of the present disclosure is presented, and other disclosures that are degenerative by addition, change, deletion, or the like of other components or other embodiments included within the scope of the present disclosure are easily suggested.

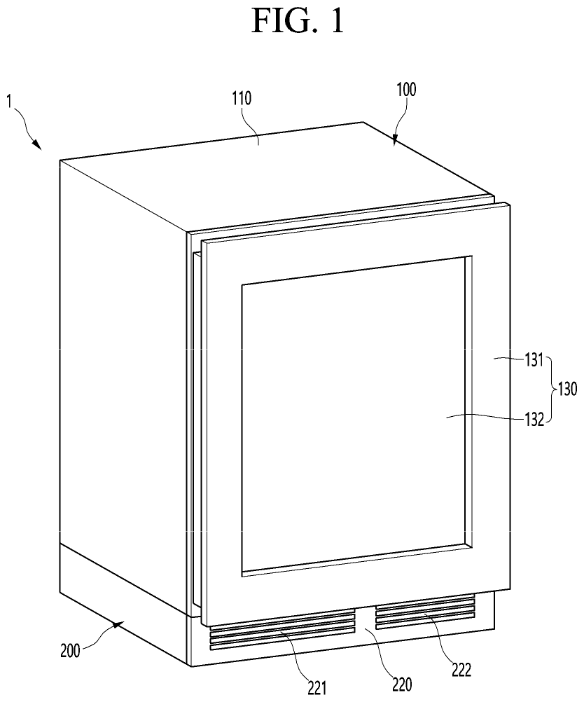

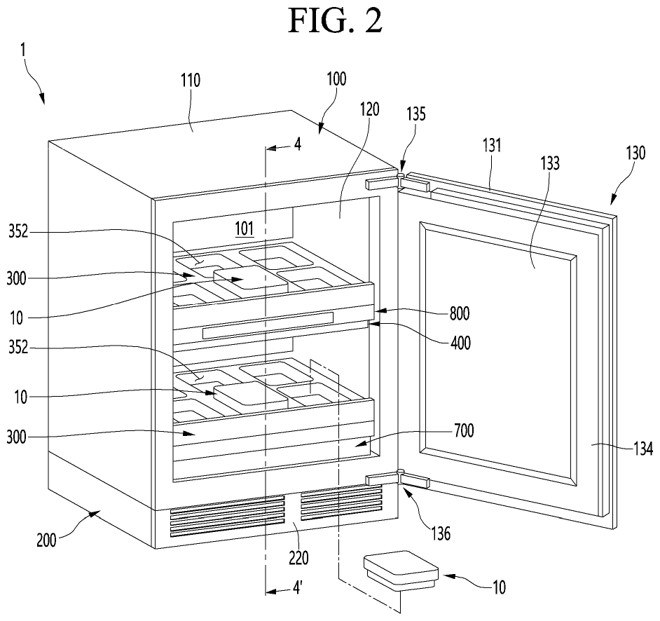

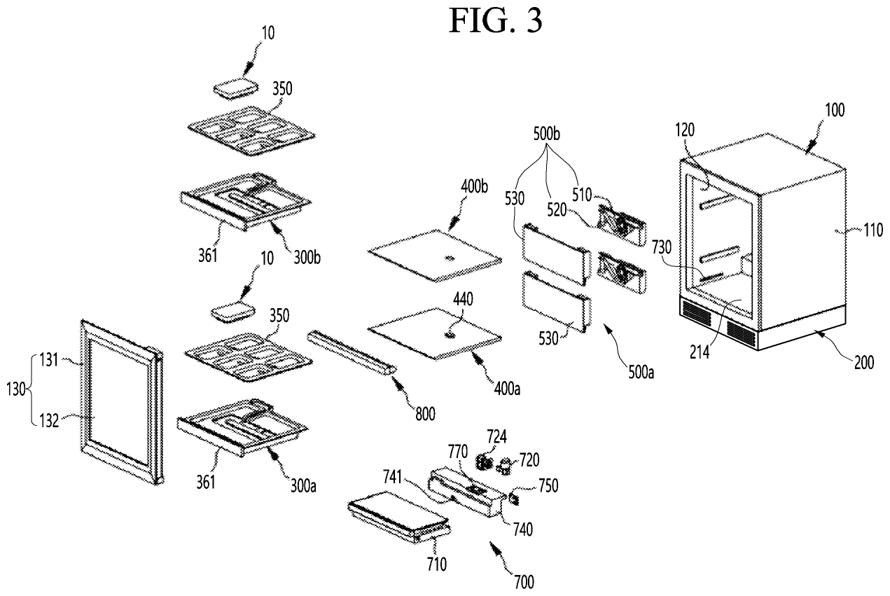

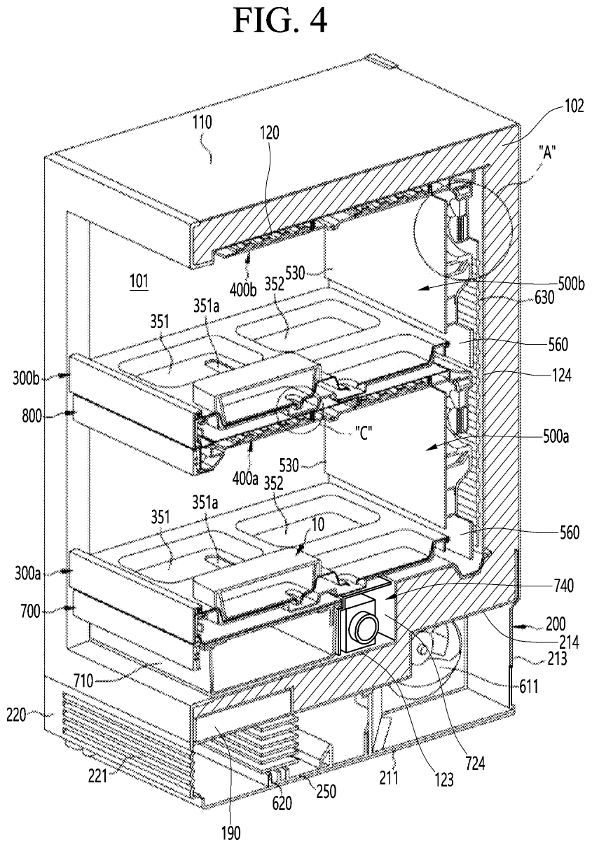

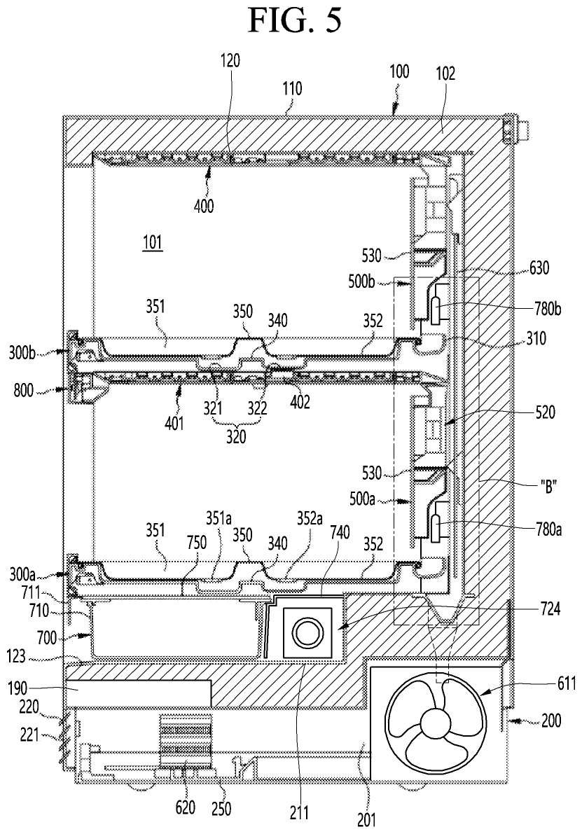

FIG. 1 is a perspective view illustrating a plant cultivation apparatus to which a water supply apparatus according to an embodiment of the present disclosure is applied, FIG. 2 is a perspective view illustrating a state where a door of the apparatus for cultivating plants is opened, FIG. 3 is an exploded perspective view illustrating the apparatus for cultivating plants, FIG. 4 is a cutaway perspective view taken along line 4-4′ of FIG. 2, and FIG. 5 is a longitudinal cross-sectional view illustrating the cabinet. Looking at the whole with respect to the apparatus for cultivating plants 1 according to the embodiment of the present disclosure with reference to the drawings, the outer appearance thereof may be formed by a cabinet 100 forming a space in which a plant is cultivated therein, and a door 130 for opening and closing the cabinet 100. In this case, the cultivated plant is usually edible by the user, such as leaf vegetables and herbs that can be used for wrapping or salads, and is easy to cultivate, and it is preferable that plants that do not occupy a lot of space are cultivated, and may be provided in the form of a pod 10 which includes seeds and nutrients.

The cabinet 100 is formed to have an open front surface, and a cultivation space 101 may be provided therein. The cabinet 100 may include an outer case 110 forming an outer appearance and an inner case 120 forming the cultivation space 101, and an insulating material 102 may be provided between the outer case 110 and the inner case to insulate the cultivation space and maintain the cultivation space 101 at a set temperature. The cultivation space 101 may be referred to as a first space.

The outer case 110 and the inner case 120 may be formed of a metal material and may be formed by combining a plurality of plate-shaped materials with each other. In particular, the inner case 120 may have both side surfaces, a rear surface, and an upper surface formed in a metal plate shape and may be coupled to each other.

A plurality of beds 300 may be vertically disposed inside the cabinet 100. In this embodiment, two beds 300a and 300b are vertically provided and may have the same structure. The beds 300 may be referred to as an upper bed 300b and a lower bed 300a, respectively, for convenience of explanation and understanding. Of course, two or more beds 300 may be provided according to the size of the cabinet 100.

The bed 300 may have a structure in which a plurality of pods 10 containing plant seeds and nutrients necessary for cultivation are seated. The bed 300 may be referred to as a shelf or a tray. In addition, the bed 300 may have a structure in which the pod 10 can be seated and maintained in a seated state. In addition, the bed 300 may have a structure which easily seats the pod 10 and can introduce/withdraw so that management and harvesting of plants growing in the pod 10 is facilitated.

In addition, the bed 300 may have a structure in which water supplied from the water tank 700 flows and is delivered to all the pods 10 seated on the bed 300. In addition, the bed 300 may maintain an appropriate water level so as to constantly supply moisture to the pod 10.

Meanwhile, a machine room 200 may be provided below the cabinet 100. In the machine room 200, a compressor 610 and a condenser 620 constituting a refrigeration cycle for adjusting the temperature of the cultivation space 101 may be disposed.

In addition, a grill cover 220 may be provided on the front surface of the machine room 200, and the grill cover 220 may include a grill suction port 221 through which air is suctioned into the machine room 200, and a grill discharge port 222 through which internal air of the machine room 200 is discharged.

Meanwhile, the internal temperature of the cultivation space may be adjusted by the refrigeration cycle 600. In this case, the evaporator 630 may be disposed on the inner rear wall surface of the cultivation space 101. The evaporator 630 may be provided with a roll bond type heat exchanger and may be referred to as a heat exchanger. The evaporator 630 may have a plate-shaped structure that is easily attached to the rear wall surface of the cultivation space 101. In addition, the evaporator 630 minimizes the loss of the cultivation space 101 due to the plate-like structure and is close to the cultivation space 101 to effectively adjust the temperature of the cultivation space 101.

A heater (not illustrated) may be provided on the rear wall surface of the cultivation space 101. Accordingly, heating and cooling may be performed in the rear area of the cultivation space. The interior of the cultivation space 101 by the evaporator 630 and the heater may maintain a temperature suitable for plant growth (eg, 18° C.-28° C.). Of course, if necessary, a configuration for heating other than the heater may be provided, and various heating methods such as a heating structure through hot gas or a heating structure through conversion of a refrigeration cycle will be possible. The temperature inside the cultivation space 101 is sensed by the internal temperature sensor 450, and can be kept constant regardless of the external temperature of the cabinet 100.

In addition, a blower assembly 500 may be provided in front of the evaporator 630. The blower assembly 500 may circulate the interior of the cultivation space 101 to uniformly cool or heat the cultivation space 101.

The blower assembly 500 may include an upper blower assembly 500b disposed in an upper space divided by the bed 300 and a lower blower assembly 500a disposed in a lower space. The blower assembly 500 disposed vertically has the same structure and shape, except that there is a difference only in the mounting position. The blower assembly 500 may be provided by a number corresponding to the number of the beds 300 and may blow air from the rear toward the front of the bed 300. Accordingly, independent air circulation can be achieved in each space of the interior of the cultivation space 101 partitioned by the bed 300.

The air in the interior of the cultivation space is circulated by the blower assembly 500, and in particular, the circulated air passes through the evaporator 630 so that the entire interior of the cultivation space 101 has a uniform temperature, while temperature adjustment can be rapidly achieved. In addition, the air circulated by the blower assembly 500 may flow while passing through the upper surface of the bed 300 and the lower surface of the light assembly 400.

The air flowing by the blower assembly 500 passes through the upper surface of the bed 300 to make the respiration of the plants grown in the bed 300 more smooth and to make the plants to be shaken appropriately and thus the air can provide the optimal airflow necessary for growth by controlling stress. In addition, the air flowing by the blower assembly 500 can prevent overheating of the light assembly 400 while passing through the lower surface of the light assembly 400.

Meanwhile, the light assembly 400 may be provided above the bed 300. The light assembly 400 provides light necessary for plants by irradiating light toward the bed 300. In this case, the amount of light irradiated by the light assembly 400 may be set to be similar to sunlight, and the amount of light and irradiation time optimized for the cultivated plant may be set.

The light assembly 400 may include an upper light assembly 400b provided in an upper space partitioned by the bed 300 and a lower light assembly 400a provided in a lower space. The upper light assembly 400b may be mounted on an upper surface of the cultivation space 101, and the lower light assembly 400a may be mounted on a lower surface of the upper bed 300b.

In other words, the upper light assembly 400b and the lower light assembly 400a may be positioned vertically above the bed 300 disposed below, respectively, and on the upper surface of the partitioned cultivation space 101, it is possible to adjust the growth of cultivated plants by irradiating light toward the bed 300.

A water tank 700 may be provided on a bottom surface inside the cabinet 100. The water tank 700 may store water supplied to the bed 300. The water tank 700 may be positioned below the bed 300 positioned at the lowermost position among the plurality of beds 300, and the front surface the water tank may be positioned at a position corresponding to the front end of the bed 300.

The length of the water tank 700 in the horizontal direction may correspond to the width of the internal space of the cabinet 100. In addition, the length of the water tank 700 in the vertical direction may be formed to correspond to a distance between the bed 300 positioned at the lowermost position and the bottom surface of the cultivation space 101. In other words, the water tank 700 may be formed to fill the entire space below the lower bed 300a positioned at the lowermost position, and the space behind the water tank 700 can be covered by the water tank 700.

A pump cover 740 may be provided in a space behind the water tank 700 covered by the water tank 700. A water pump 720 and a water supply valve 724 to be described below may be provided inside the pump cover 740. The pump cover 740 and the internal components of the pump cover 740 and the pipe connected to the components may be referred to as a water supply unit or a water supply module. In addition, the water supply module, the water tank 700, and related components disposed for supplying water in the cabinet 100 may be referred to as water supply apparatus.

The water tank 700 may be provided in the interior of the cultivation space 101 to be capable of being introduced or withdrawn in a front and rear direction. To this end, tank rails 730 for guiding the introduction/withdrawal of the water tank 700 may be provided on both sides of the water tank 700 in the left and right directions. In addition, the water tank 700 may be opened in a state of being introduced or withdrawn to have a structure in which water can be additionally supplied.

Meanwhile, the display assembly 800 may be provided in the opened front half portion of the cabinet 100. The display assembly 800 may output the operating state of the apparatus for cultivating plants 1 to the outside. In addition, the display assembly 800 may be provided with a manipulation part to which a user's manipulation is input to set and input the overall operation of the apparatus for cultivating plants. For example, the display assembly 800 may include a touch screen structure and may include a structure such as a button or a switch.

The door 130 may have a size capable of shielding the opened front surface of the cabinet 100. In addition, an upper hinge 135 and a lower hinge 136 may be shaft-coupled to the upper end and lower end of one of the sides of the door 130 in the left and right direction. The door 130 may be rotatably coupled to the cabinet 100 by the upper hinge 135 and the lower hinge 136, and the cultivation space 101 can be opened and closed by the rotation of the door 130.

At least a part of the door 130 may have a see-through structure, and the cultivation space 101 may be checked even when the door 130 is closed.

In detail, the door 130 may include a door frame 131 forming a circumference and having an opening in the center, and door panels 132 and 133 for shielding the opening of the door frame 131. The door panels 132 and 133 may be formed of glass or a transparent plastic material to have a structure in which the inside can be seen through. In addition, the door panels 132 and 133 may have a color or a colored coating, metal deposition, or film attached thereto so that the cultivation space 101 is selectively visible or invisible.

Meanwhile, a plurality of the door panels 132 and 133 may be disposed in the front and rear direction, and an insulating space may be formed between the plurality of door panels 132 and 133. In addition, if necessary, the door panels 132 and 133 may include insulating glass. Accordingly, it is possible to insulate the inside and the outside of the cabinet 100.

In addition, if necessary, the entire front outer appearance of the door 130 may be formed by the door panel 132 disposed on the front surface of the door 130.

Meanwhile, components of reference numerals not described in FIGS. 1 to 5 will be described below.

Hereinafter, the structure of the apparatus for cultivating plants 1 having the above structure will be described in more detail with reference to the drawings for each configuration.

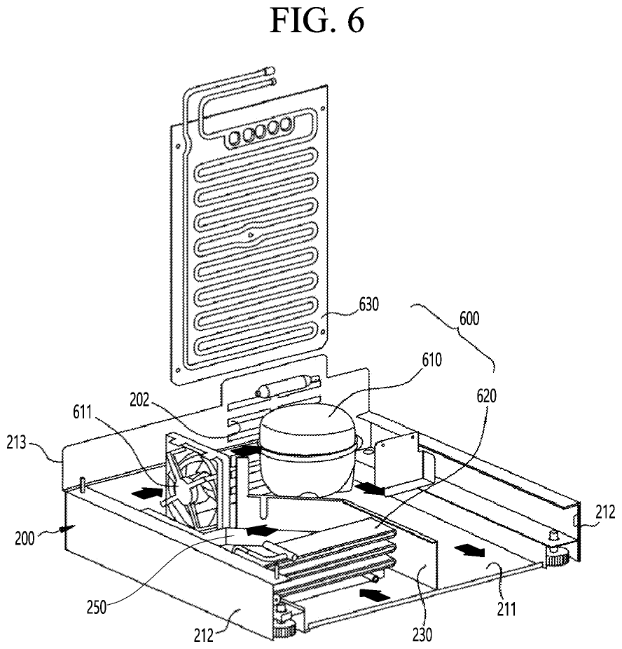

FIG. 6 is a perspective view illustrating the internal structure of the machine room of the apparatus for cultivating plants.

As illustrated, the machine room 200 is mounted on the lower surface of the cabinet 100 and forms a space independent from the cultivation space 101 under the cabinet 100. The machine room 200 may be configured by a bottom plate 211 forming a lower surface, a pair of side plates 212 forming both side surfaces, and a rear plate 213 forming a rear surface.

The bottom plate 211, the side plate 212, and the rear plate 213 may be coupled in a single module form to be referred to as a machine room frame. The space formed by the machine room frame may be formed so that the upper surface and the front surface are opened. Accordingly, the machine room frame is coupled to the lower surface of the cabinet 100 to form the machine room 200 space under the cabinet 100. The internal space of the machine room 200 may be partitioned by a barrier 230.

The barrier 230 may extend backward from the opened front end of the machine room 200. A condenser 620 may be provided in a space on the left side partitioned by the barrier 230, and a compressor 610 may be provided on a space on the right side partitioned by the barrier 230. In addition, a heat dissipation fan 611 for forcibly flowing air from the left to the right may be provided at the rear end of the barrier 230.

Meanwhile, a grill cover 220 may be provided on the opened front surface of the machine room 200. The grill cover 220 shields the open front surface of the machine room 200, a grill suction port 221 is formed in the front surface of the left space partitioned by the barrier 230, and a grill discharge port 222 may be formed in the front surface of the right space, respectively.

Accordingly, when the heat dissipation fan 611 is driven, external air is suctioned and flows into the left space of the machine room 200 through the grill suction port 221, and the suctioned air exchanges heat with the refrigerant in the condenser 620 while passing through the condenser 620. Then, the air passing through the heat dissipation fan 611 cools the compressor 610 while passing through the compressor 610. Also, the air passing through the compressor 610 may be discharged forward through the grill discharge port 222.

In other words, in a state where the apparatus for cultivating plants 1 is installed, both the suction of external air and the discharge of the air inside the machine room 200 are performed from the front while passing through the grill cover 220. Accordingly, the apparatus for cultivating plants 1 can be installed even in a space where the left and right sides and the rear surface are blocked. In particular, even if the apparatus for cultivating plants 1 is installed in a piece of furniture such as a sink as a built-in, cooling and heat exchange of the compressor 610 and the condenser 620 inside the machine room 200 can be effectively performed.

Meanwhile, the evaporator 630 constituting the refrigerating cycle 600 is provided inside the cabinet 100, is vertically disposed on the rear surface of the cultivation space 101, and can be easily connected by components and refrigerant pipes in the machine room 200.

A condensate receiver 250 is provided in the machine room 200. At this time, the condensate receiver 250 may be provided below the condenser, and the condensate flowing down from the condenser 620 may be stored, and water discharged from the cultivation space 101 may be stored.

Meanwhile, the upper side of the machine room 200 may be provided with a controller 190 for controlling the operation of each component of the apparatus for cultivating plants. For example, the controller 190 may be provided between the upper surface of the machine room and the inner bottom surface of the cultivation space 101 and may be accessible by opening the grill cover 220. Therefore, even when the apparatus for cultivating plants is installed and in use, the controller 190 can be easily accessed, and maintenance can be facilitated.

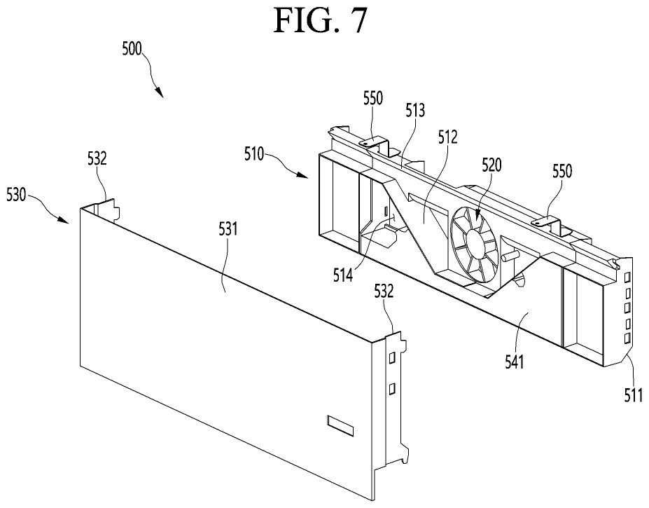

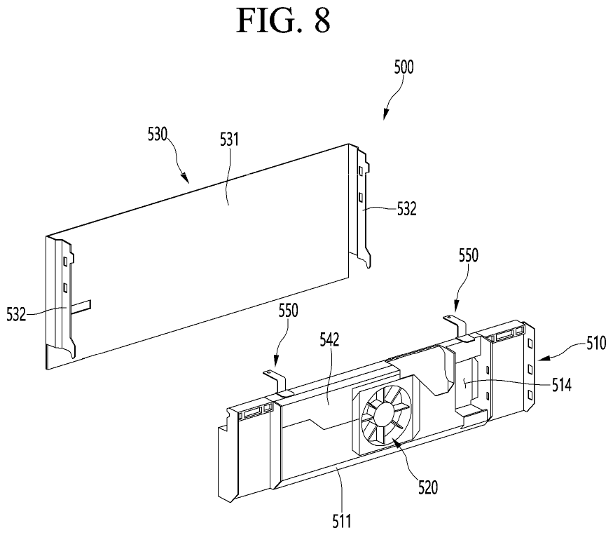

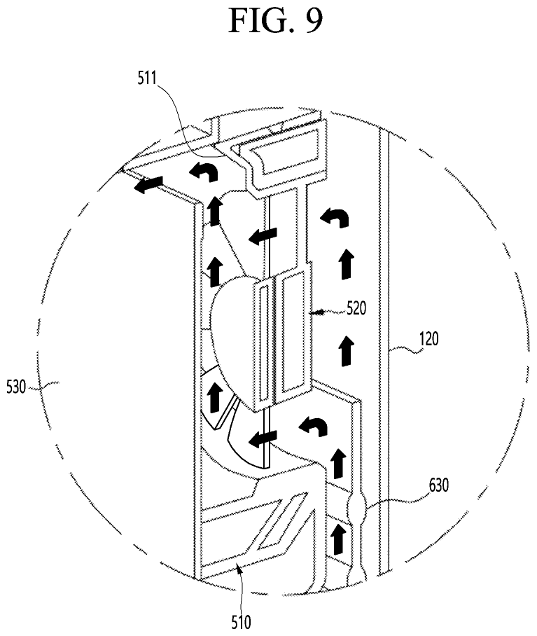

FIG. 7 is an exploded perspective view illustrating the blower assembly of the apparatus for cultivating plants viewed from the front, FIG. 8 is an exploded perspective view illustrating the blower assembly viewed from the rear, and FIG. 9 is an enlarged view illustrating part “A” of FIG. 4.

As illustrated in the drawing, the evaporator 630 may be provided on the rear wall surface of the cultivation space 101, and the blower assembly 500 may be provided in front of the evaporator 630.

The blower assembly 500 is configured to circulate air above the cultivation space 101 partitioned by the bed 300. Accordingly, the blower assembly 500 is provided in a number corresponding to the number of the beds 300 and is provided at the lower end of the light assembly 400 and at an upper portion adjacent to the bed 300.

As illustrated in the drawing, the blower assembly 500 may include a blower fan 520, a fan guide 510 to which the blower fan 520 is mounted, and a blower cover 530 shielding the fan guide 510 and the evaporator 630.

In detail, the blower fan 520 is formed in the shape of a box fan and may be provided in the center of the fan guide 510. In addition, the blower fan 520 may discharge the air flowing thereinto from the rear to the front of the blower assembly 500. The fan guide 510 provides a space in which the blower fan 520 is mounted and is configured to guide the discharge of air discharged by the blower fan 520. The fan guide 510 is injection-molded with a plastic material, and the blower fan 520 may be mounted in the center of the rear surface of the fan guide 510.

Meanwhile, an air guide 512 is formed on the front surface of the fan guide 510 to guide air discharged from the blower fan 520 upward. The air guide 512 may be provided on both sides in the left and right direction with respect to the center of the blower fan 520 and may be configured to become wider toward the upper side. Accordingly, the air discharged by the blower fan 520 flows along the inclined surface and may become closer to the discharge port formed at the upper end of the fan guide 510 toward the outside.

A discharge guide 513 may be formed on the front upper end of the fan guide 510. The discharge guide 513 forms a surface that protrudes forward from the lower side to the upper side. In other words, the discharge guide 513 forms an inclined surface or a round surface, and guides the air flowing from the lower side to the upper side toward the front. At this time, since the end portion of the discharge guide 513 is adjacent to the lower surface of the light assembly 400, the air discharged from the blower assembly 500 can flow from rear end to the front side of the lower surface of the light assembly 400 by the discharge guide 513. The light assembly 400 can be cooled when the light assembly 400 is heated by such an air flow.

A connector hole 514 may be formed at one side of the fan guide 510. The connector hole 514 is formed to be opened at a position corresponding to the connector 124a mounted on the rear wall surface of the inner cultivation space. Therefore, when the blower assembly 500 is mounted, the connector 124a is inserted into the connector hole 514 so as not to interfere with each other. In addition, the electric wire connected to the blower fan 520 may be connected to the connector exposed through the connector hole 514.

Blower brackets 550 that are inserted into and mounted on the blower assembly mount 415 may be provided on both sides of the upper surface of the fan guide 510 in the left and right direction. One end of the blower bracket 550 may be coupled to the upper surface of the fan guide 510, and the other end thereof may be mounted to the blower assembly mount 415 formed at the rear end of the lower surface of the light assembly 400. Accordingly, the light assembly 400 and the blower assembly 500 may be coupled to each other in a vertically intersecting form. In addition, the blower assembly 500 may discharge air from the rear end of the light assembly 400 toward the front.

In addition, an inlet guide 511 may be formed on a lower surface of the fan guide 510. The inlet guide 511 may be inclined upward toward the rear and may guide air suctioned in from the lower side of the fan guide 510 to smoothly flow to the rear of the fan guide 510.

In addition, recessed spaces are formed in the front and rear surfaces of the fan guide 510, and a front insulating material 541 and a rear insulating material 542 may be disposed inside the recessed space, respectively. Accordingly, it is possible to prevent the cold air generated in the evaporator 630 from being transmitted to the front directly through the blower assembly 500.

Meanwhile, the blower cover 530 may shield the fan guide 510 and components mounted on the fan guide 510 in front of the fan guide 510. In addition, the blower cover 530 is extended to a position adjacent to the upper end of the bed to be capable of preventing the evaporator 630 and the rear wall surface of the inner case 120 from being exposed in a case where the blower assembly 500 is mounted.

In addition, the blower cover 530 and the bed 300 may be slightly spaced apart to each other, and the air flowing into the rear along the bed 300 through between the lower end of the blower cover 530 and the upper surface of the bed 300 may be suctioned to face the blower fan 520.

At this time, in order to prevent the evaporator 630 from being exposed through the gap between the blower cover 530 and the bed 300, a shielding plate 560 can be further provided in a corresponding area of the evaporator 630.

The blower cover 530 may form the outer appearance of the rear wall surface of the cultivation space 101.

The blower cover 530 may be formed of the same metal material as the inner case 120 and may be formed by bending a plate-shaped material. The blower cover 530 may include a front portion 531 and a side portion 532.

The front portion 531 may be exposed through the cultivation space 101 and may be formed to correspond to a horizontal length of the cultivation space 101. In addition, the upper end of the front portion 531 may be positioned adjacent to the upper end of the fan guide 510 and the upper end of the light assembly 400, and serves as an outlet through which the air substantially discharged by the blower fan 520 is discharged into the cultivation space 101. The lower end of the front portion 531 may extend further downward than the lower end of the fan guide 510 and may be positioned adjacent to the upper surface of the bed 300, and serves as a suction port in which air suctioned substantially toward the blower fan 520 flows.

In other words, by the blower cover 530, the rear components are shielded and the rear outer appearance of the cultivation space 101 is formed, and at the same time, the blower cover may serve as a suction port for air flowing along the bed 300 and a discharge port for air discharged along the light assembly 400 so that air circulates in the cultivation space 101. In particular, the structure of the blower assembly 500 may allow air to flow along the bed 300 and the light assembly 400, and while flowing along the rear of the fan guide 510, the evaporator 630 or the air cooled or heated by the heater continuously circulates inside the cultivation space 101, so that the temperature of the cultivation space 101 can be adjusted. Through this continuous circulation of air, the cultivation space 101 maintains a constant temperature as a whole, and the inside of the cultivation space can be in an optimal state, such as providing airflow for plants to grow inside the bed 300.

The side portion 532 may be bent backward at both ends of the front portion 531 and may be coupled to both side surfaces of the fan guide 510. The side portion 532 may have a coupling structure corresponding to the side surface of the fan guide 510 and may be coupled to each other by the elasticity of the side portion 532 itself without fastening a separate coupling member.

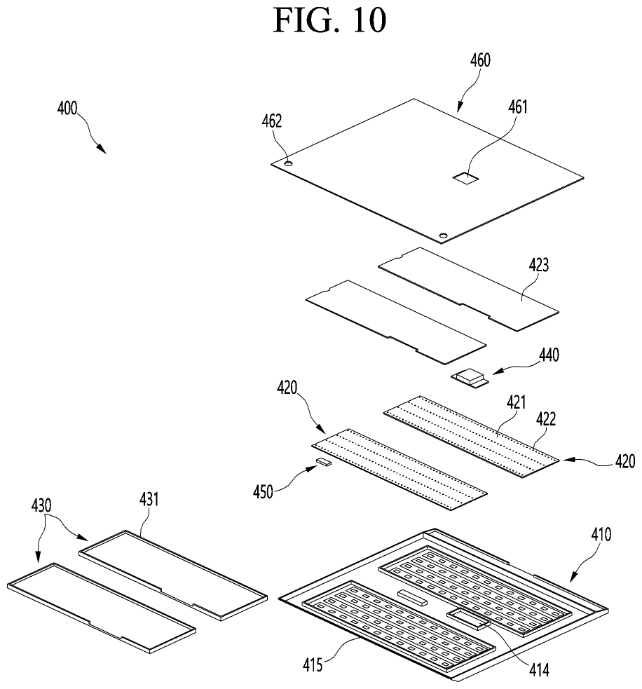

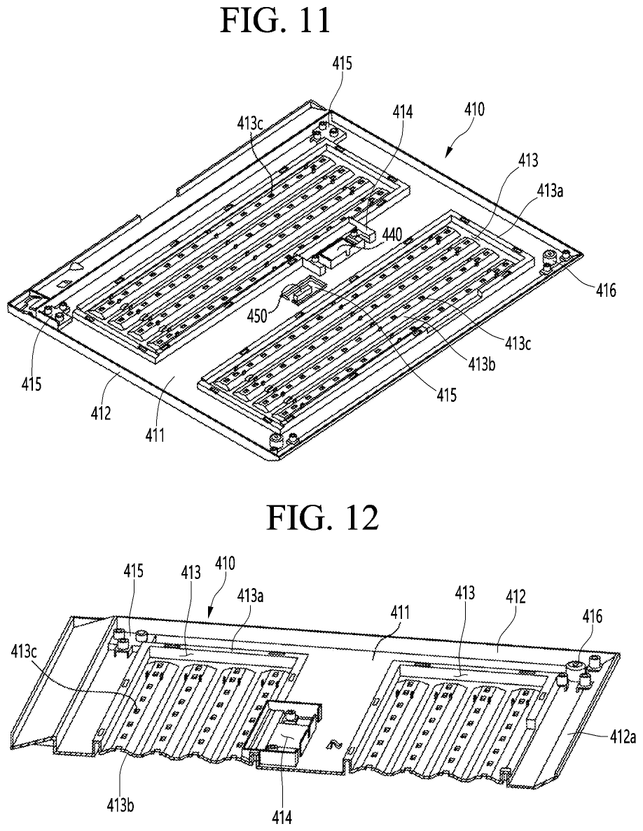

FIG. 10 is an exploded perspective view illustrating the light assembly of the apparatus for cultivating plants, FIG. 11 is a perspective view illustrating a light case of the light assembly, and FIG. 12 is a cutaway perspective view illustrating the light case.

As illustrated in the drawing, the light assembly 400 may have a size corresponding to the upper surface of the cultivation space 101 or the bed 300. Therefore, light can be evenly irradiated to the entire area of the bed 300 disposed below.

The light assembly 400 may include a light case 410 which has an open lower surface and in which the LED module 420 can be accommodated, and a cover plate 460 for shielding the opened upper surface of the light case 410.

The light case 410 may include a bottom surface 411 formed in a rectangular plate shape, and a case edge 412 extending upward along the circumference. Meanwhile, the front surface 412a of the case edge 412 may be inclined to minimize exposure of the light assembly 400 when the user opens the door 130.

A module mount 413 may be formed in the front half portion and the rear half portion based on the center of the bottom surface 411 of the light case 410. The module mount 413 is a part on which the LED module 420 is mounted and may be configured to mount a plurality of LED modules 420. When the LED module 420 is configured as one, there is a problem that the entire LED module 420 has to be replaced when an abnormality occurs in the LED module 420, and in a case where the number of the LED modules 420 is too large, there is a problem in that mounting and assembly of the LED modules are difficult and the disposition of electric wires connected to the LED module 420 is not easy. Accordingly, the LED module 420 is composed of two and disposed in the front and rear direction, and a space in which a temperature sensor mount 415 and a residual water detection device mount 414 for disposing a temperature sensor 450 and a residual water detection sensor 440 can be secured between the LED modules 420.

Meanwhile, since the bed 300 is not provided on the upper light assembly 400b of the light assembly 400 mounted on the upper surface of the cultivation space, the residual water detection sensor 440 may not be provided. The residual water detection device mount 414 may be formed in both the upper light assembly 400b and the lower light assembly 400a, but the residual water detection sensor 440 is provided only in the lower light assembly 400a and thus can be detected whether there is residual water on the upper bed 300b.

The module mount 413 may be defined by a mount edge 413a. The mount edge 413a protrudes upward along the circumference of the LED module 420, and thus a space in which the LED module 420 is accommodated by the mount edge 413a may be formed. The mount edge 413a has a protruding shape when viewed from above, and has a recessed shape when viewed from below, so that the light cover 430 to be described below can be mounted thereon.

A light groove 413b may be formed inside the module mount 413. The light groove 413b is formed along the disposition of the LEDs 422 provided in the LED module 420, extends from the left end to the right end inside the module mount 413, and can be disposed continuously in the front and rear direction.

The light groove 413b may have a protruding shape when viewed from above and have a recessed shape when viewed from below. In addition, a plurality of LED holes 413c may be formed along the protruding center of the light groove 413. The LED holes 413c may be formed at corresponding positions to allow the LEDs 422 to be installed thereon. In addition, both sides of the light groove 413b are inclined or rounded around the LED hole 413c so that the light irradiated from the LED 422 can be reflected through the light groove 413b and irradiated downward. In addition, the inner surface of the light groove 413b may be surface-treated or coated to more effectively reflect light.

The LED module 420 may be configured such that a plurality of LEDs 422 are mounted on a substrate 421. The substrate 421 may be formed to have a size corresponding to that of the module mount 413, and thus may be fixed inside the mount edge 413a.

In addition, a plurality of the LEDs 422 may be continuously disposed at regular intervals on the substrate 421. In this case, the LED 422 may be disposed at a position corresponding to the LED hole 413c. The LED 422 may be configured to have a light quantity (wavelength) similar to sunlight and may be configured to irradiate light of a color capable of promoting photosynthesis of plants.

In addition, a cover sheet 423 may be provided above the LED module 420. The cover sheet 423 is to prevent moisture penetration into the substrate 421 or contamination damage thereof and may be formed in a size capable of completely shielding the substrate 421 from above. The cover sheet 423 may be formed of a dielectric material, and may be formed of an insulating material to prevent heat from penetrating upward during the operation of the LED 422.

Meanwhile, an electric wire guide 417 for guiding electric wires connected to the LED module 420 may be formed inside the light case 410. The electric wire guide 417 is positioned on one of both sides in the left and right direction and may be disposed in the front and rear direction along the space between the module mount 413 and the edge 412. Accordingly, the electric wire connected to the LED module 420 may be guided to the rear end of the light case 410 and may be connected to the connector 124a on the rear surface of the cultivation space 101.

In addition, blower assembly mounts 415 in which the blower assembly 500 can be mounted may be formed on both sides of the rear end of the light case 410. The blower assembly mount 415 may be formed by recessing the lower surface of the light case 410 so that the blower brackets 550 provided on both upper sides of the blower assembly 500 can be inserted.

The cover plate 460 may have a size corresponding to the size of the light case 410 and is formed in a plate shape to shield the opened upper surface of the light case 410. Boss holes 462 corresponding to mounting bosses 416 formed at four corners of the light case 410 may be formed in the cover plate 460. In addition, the screw fastened below the mounting boss 416 may pass through the boss hole 462 to be fastened to the surface on which the light assembly 400 is mounted.

In addition, a sensor hole 461 may be formed at a position corresponding to the residual water detection sensor 440 in the cover plate 460. Therefore, the residual water detection device provided with the residual water detection sensor 440 may be exposed upwards of the cover plate 460 and contact the lower surface of the bed 300 disposed above to detect residual water inside the bed 300. Of course, since the bed 300 is not disposed above the uppermost light assembly 400b among the light assemblies 400, the residual water detection device and the sensor hole 461 may be omitted.

A plurality of light assemblies 400 may be provided in a case where the cultivation space 101 is partitioned by a multi-stage bed 300. In addition, the uppermost light assembly 400 may be fixedly mounted on the upper surface of the cultivation space 101, and the lower light assembly 400 may be fixedly mounted adjacent to the lower surface of the bed 300 at the lower side of the bed 300. In this case, the screw fastened for mounting the light assembly 400 may be fastened through the mounting boss 416 and the boss hole 462.

Meanwhile, a light cover 430 may be provided on a lower surface of the light case 410. The light cover 430 is mounted on the light case 410 to form a portion of the lower surface of the light case 410, shields the module mount 413 from below, and can be configured to protect the LED 422 disposed therein.

The light cover 430 may be formed of a transparent material to allow light to pass through, and a coating or surface treatment for light diffusion may be added to the light cover 430.

A cover edge 431 bent upward may be formed around the light cover 430, and the cover edge 431 may be inserted into the recessed inside of the mount edge 413a to be fixedly mounted.

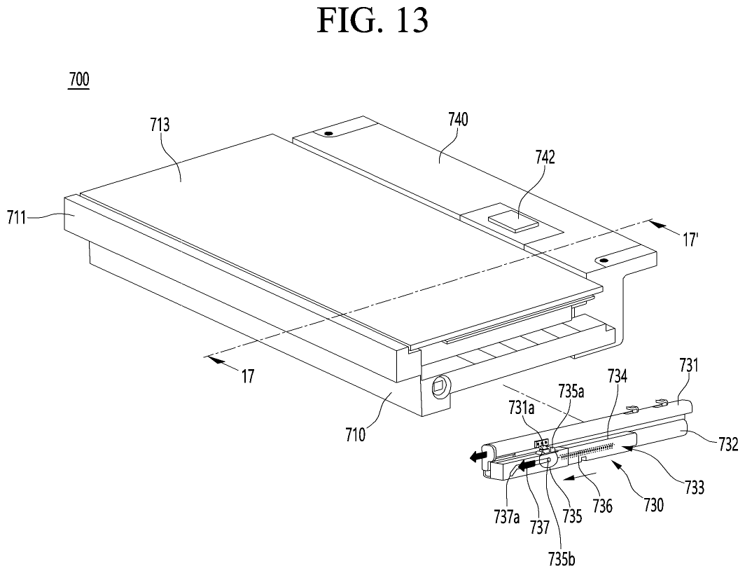

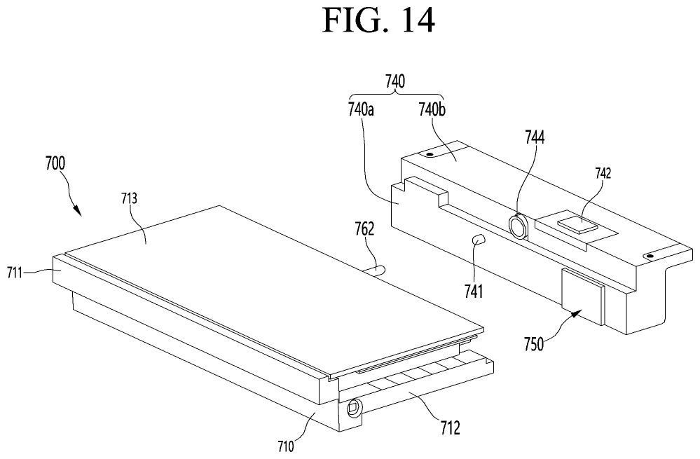

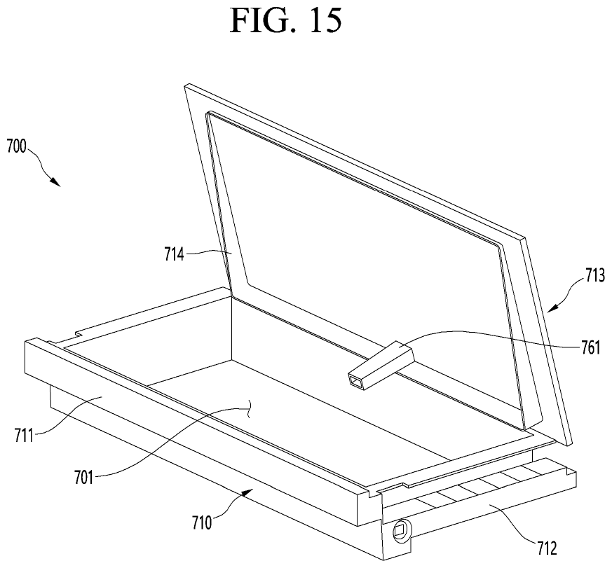

FIG. 13 is a perspective view illustrating a water supply module of the plant cultivation apparatus, FIG. 14 is an exploded perspective view illustrating the water supply module, and FIG. 15 is a perspective view illustrating a state where a water tank constituting the water supply module is opened.

As illustrated in the drawing, the water supply module is for supplying water to the pod 10 for cultivation of crops, and the water stored in the apparatus for cultivating plants 1 can be configured to be supplied as much as an appropriate amount at an appropriate time.

In particular, in this embodiment, only water may be supplied through the water supply module, and nutrients may be provided through the pod 10. In other words, various nutrients required for a variety of crops can be provided through the pod 10, and even if different types of pods 10 are provided in one bed 300, nutrients can be provided from each pod. In addition, water may be supplied from the water supply module, and accordingly, constituents other than water are not stored or flow inside the water supply module, so that contamination is prevented and a clean state can be maintained.

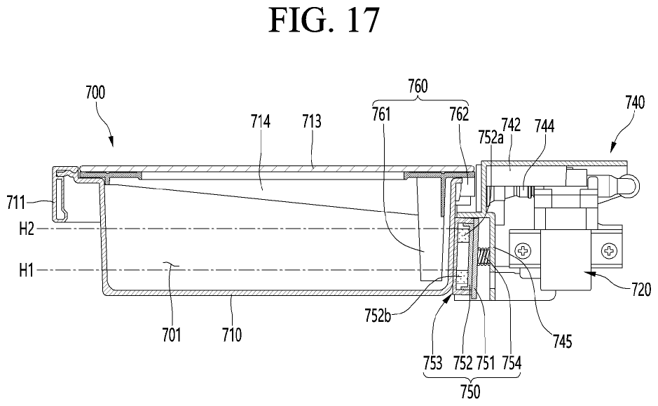

The water supply module may include a water tank 700 for storing water for water supply, a water pump 720 (in FIG. 17) for forcibly supplying water from the water tank 700, and a pump cover 740 that forms a mounting space for the water pump 720 and shields the components including the water pump 720. The mounting space formed by the pump cover 740 may be referred to as a second space.

In detail, the water tank 700 includes a tank body 710, and the tank body 710 is formed in a rectangular box shape with an open upper surface, so that water supplied to the bed 300 can be accommodated therein. In addition, the tank body 710 may be formed to have a width corresponding to the horizontal length of the cultivation space 101 and can be formed to fill the space between the bottom surface of the cultivation space 101 and the bottom surface of the bed 300.

A tank cover 713 may be provided on the opened upper surface of the tank body 710. The tank cover 713 is for opening and closing the opened upper surface of the tank body 710, and a rear end thereof may be rotatably coupled to the upper surface of the tank body 710. Accordingly, the user may fill the inside of the water tank 700 with water after opening the tank cover 713.

A cover rib 714 may be formed on a lower surface of the tank cover 713. When the tank cover 713 is closed, the cover rib 714 may be formed to contact the circumference of the opened upper surface of the tank body 710. Accordingly, it is possible to prevent the internal water from leaking between the tank body 710 and the tank cover 713 when the tank cover 713 is closed.

In addition, a connection pipe 760 may be provided at the rear end of the tank cover 713 to guide the water in the water tank 700 to the pump 720. The structure of the connection pipe 760 will be described in more detail below.

In addition, tank rails 730 may be provided on both side surfaces of the tank body 710 in the left and right direction. The tank rail 730 is for introduction or withdrawal of the water tank 700 and may have a sliding introduction or withdrawal structure. In addition, one end of the tank rail 730 is fixed to the side surface of the tank body 710, and the other end thereof is fixed to both sides of the inner case 120 to guide the introduction/withdrawal of the water tank 700.

In addition, the tank rail 730 may further include a closing module 733. The closing module 733 is operated in a case where the water tank 700 reaches a set position when the water tank 700 is introduced to force the water tank 700 to be completely introduced, which is referred to as an auto closing device.

The closing module 733 may include, as a whole, a module case 734, a cam member 735, a locking member 731a, and an elastic member 736.

In detail, the tank rail 730 may include a moving rail 731 coupled to the water tank 700 and moving together with the water tank 700, and a fixed rail 732 for fixed inside the cultivation space 101 and guiding the movement of the moving rail 731. The moving rail 731 may be positioned above the fixed rail 732.

A locking member 731a extending downward may be provided on the outer surface of the moving rail 731. The locking member 731a is selectively coupled to and moved with the cam member 735, may be positioned at a position corresponding to the cam member 735, and can be inserted into an insertion groove 735a of the cam member 735.

In addition, the module case 734 may be provided on the outer surface of the fixing rail 732. The module case 734 may be configured to accommodate the cam member 735 and the elastic member 736. A portion of the upper surface of the module case 734 may be opened. In detail, the upper surface of the module case 734 may be opened on a path through which the cam member 735 moves, and the upper portion of the cam member 735 may be exposed through the upper surface of the module case 734.

In addition, the insertion groove 735a may be formed in an upper portion of the cam member 735 exposed through the upper surface of the module case 734. Accordingly, the locking member 731a may be selectively coupled to the insertion groove 735a according to the movement of the moving rail 731, and the locking member 731a may be moved in the front and rear direction together with the cam member 735 in a state of being inserted into the insertion groove 735a.

An end portion of the elastic member 736 may be connected to a lower end of the cam member 735. One end of the elastic member 736 may be connected to the cam member 735 and the other end thereof may be fixed inside the module case 734. A spring may be used for the elastic member 736, may be tensioned when the cam member 735 moves forward, and may provide an elastic force for the cam member 735 to return to the initial position thereof. The elastic member 736 may have a structure in which a state where the cam member 735 is positioned at the rearmost position becomes an initial state and is gradually tensioned as the cam member 735 moves forward.

The cam member 735 may be moved in the front and rear direction along the module case 734, and guide slits 737 may be formed on both side surfaces of the module case 734 for this purpose. The guide slit 737 may be formed along a movement path of the cam member 735 in the front and rear direction. In addition, the cam shaft 735b protruding laterally from both side surfaces of the cam member 735 may pass through the guide slit 737, and thus the cam member 735 can be moved along the guide slit 737.

At this time, the guide slit 737 may be formed parallel to the introduction/withdrawal direction of the water tank 700, and a rotation guide 737a formed to have a downward inclination can be formed at the front end of the guide slit 737.

In detail, the cam member 735 moving along the guide slit 737 moves downward in the rotation guide 737a, and at this time, the cam member 735 is rotated in a counterclockwise direction by the engaging member 731a moving forward, and the locking member 731a may be separated from the cam member 735 by exiting the insertion groove 735a while moving further forward. In addition, the water tank 700 may be withdrawn further, and the locking member 731a may be moved together with the moving rail 731. At this time, the cam member 735 may be in a state of being moved to a maximum in the forward direction and the elastic member 736 may also be in a state of being in a maximum tensioned.

In a state where the water tank 700 is completely withdrawn, the locking member 731a and the cam member 735 are in a state of being separated from each other, and the cam member 735 is in a state of being positioned in the rotation guide 737a.

When the user pushes the water tank 700 in this state, the water tank 700 and the moving rail 731 may be moved backward. When the water tank 700 is introduced by a set distance, the locking member 731a is again inserted into the insertion groove 735a while moving backward, and the cam member 735 is moved rearward.

When the water tank 700 is further introduced, the cam member 735 leaves the rotation guide 737a, and at the same time, the cam member 735 will be pulled in the introduction direction by the restoring force of the elastic member 736.

With the movement of the cam member 735, the locking member 731a coupled to the cam member 735 is also moved rearward, so that the water tank 700 can be also automatically introduced by the elastic member 736. At this time, the water tank 700 can be completely introduced by the elastic member 736, and it is possible to ensure that the water level detection device 750 and the circumferential surface of the water tank 700, which will be described below, are in close contact with each other. In addition, the water tank 700 may be completely introduced so that the connection pipe 760 and the pipe connection portion 744 may be connected to each other.

Meanwhile, the water tank 700 may be positioned at a position corresponding to the front surface of the bed 300 in the introduction state. In addition, a tank handle 711 may be provided on the front surface of the water tank 700, and the user may withdraw the water tank 700 by holding the tank handle 711 and pulling the tank handle 711 forward.

The water tank 700 may be withdrawn as much as a distance at which the tank cover 713 may be completely exposed, and in a state where the water tank 700 is withdrawn, the tank cover 713 is opened to be capable of being filled with water in the water tank 700.

A connection pipe 760 may be formed in the water tank 700. The connection pipe 760 may be configured such that water from the water tank 700 is supplied to the water pump 720 in a state where the water tank 700 is introduced. In addition, the connection pipe 760 may be configured to be selectively connected to the pipe connection portion 721 formed on the pump cover 740 according to the introduction/withdrawal of the water tank 700.

In detail, the connection pipe 760 may be provided in the tank cover 713, may be positioned in the center of the tank cover 713 in the left and right direction and may be provided at the rear end. Accordingly, even when the tank cover 713 is rotated for opening and closing, the connection pipe 760 may be configured not to interfere with the water tank 700.

The connecting pipe 760 may include a vertical pipe 761 extending downward from the lower surface of the tank cover 713 and a horizontal pipe 762 extending rearward from the upper end of the vertical pipe 761. The vertical pipe 761 may extend downward from the tank cover 713, wherein the vertical pipe 761 may extend to a position adjacent to the bottom surface of the tank cover 713. Accordingly, the water stored in the tank cover 713 may flow upward along the vertical pipe 761.

In addition, the horizontal pipe 762 may be connected to the upper end of the vertical pipe 761 and may extend rearward. The horizontal pipe 762 may protrude further rearward than the rear surface of the water tank 700 and may extend rearward at a position corresponding to the pipe connection portion 721. The horizontal pipe 762 may be inserted into the pipe connection portion 721 in a state where the water tank 700 is fully introduced, and the water flowing upward through the vertical pipe 761 can be guided to be supplied to the pipe connection portion 721.

The horizontal pipe 762 can be completely separated from the pipe connection portion 721 in a case where the water tank 700 is withdrawn, and even if the tank cover 713 is rotated, the horizontal pipe 762 can be configured not to interfere with the pipe connection portion 721. In addition, when the rear surface of the tank cover 713 corresponding to the horizontal tube 762 is partially recessed and the horizontal tube 762 is rotated together by the rotation of the tank cover 713, the horizontal tube 762 can be prevented from interfering with the rear surface of the tank cover 713.

Meanwhile, a pump cover 740 may be provided at the rear of the water tank 700. Both ends of the pump cover 740 may be coupled to both sides of the cultivation space 101 in the left and right direction.

In addition, the pump cover 740 may include a cover front portion 740a forming a front surface and a cover upper surface portion 740b extending rearward from an upper end of the cover front portion 740a to form an upper surface. The pump cover 740 may shield the space behind the water tank 700 and may shield components other than the pump cover 740, so the pump cover 740 may be referred to as a cover member.

The bottom surface of the cultivation space 101 in which the pump cover 740 is provided has a rear half portion formed to be stepped due to the height of the compressor 610 inside the machine room 200, and the pump cover 740 may be disposed in front of the stepped portion. In addition, the water tank 700 is located in front of the pump cover 740. At this time, the upper surface of the water tank 700 and the cover upper surface portion 740b and the bottom surface of the cultivation space 101 above the compressor 610 may have the same height and may be shielded by the bed 300.

Meanwhile, a residual water detection device 742 may be provided on the upper surface of the cover upper surface portion 740b of the pump cover 740. The residual water detection device 742 is for determining whether water supplied to the lower bed 300a remains, and the residual water detection device 742 is referred to as a lower residual water detection device 742 to distinguish with the upper residual water detection device provided in the lower light assembly 400a. The upper residual water detection device and the lower residual water detection device 742 may have the same structure with only a difference in their mounting positions.

In other words, the residual water detection device 742 may include a residual water detection sensor 440 capable of detecting moisture. As an example, as the residual water detection sensor 440, a capacitive sensor may be used. The residual water detection device 742 may be configured to accurately detect whether water is present in the bed 300 by protruding upward to bring the residual water detection sensor 440 close to the lower surface of the bed 300. In order to more accurately detect whether the water remains in the bed 300, a detection portion 323 may be protruded from the bed 300, and the residual water detection device 742 has a structure which is in close contact with the detection portion 323.

Meanwhile, a tank switch 741 may be provided on the cover front portion 740a. The tank switch 741 may protrude toward the water tank 700 and may be configured to be pressed in contact with the rear surface of the water tank 700 while the water tank 700 is fully introduced.

Accordingly, the tank switch 741 may detect whether the water tank 700 is normally mounted and is in a state of being capable of supplying water and may transfer the state to the controller. When the mounting signal of the water tank 700 is not input by the tank switch 741, the pump may not be operated. In addition, information about not mounting the water tank 700 may be displayed on the display assembly 800 so that the user can recognize it. In addition, by maintaining the water tank 700 in a fully introduced state, the water level sensing performance of the water tank 700 through the water level detection device 750 may be guaranteed.

In addition, a pipe connection portion 744 may be provided on the cover front portion 740a of the pump cover 740. The pipe connection portion 744 may be formed at a position corresponding to the horizontal pipe 762 and may be selectively connected to the horizontal pipe 762 according to the movement of the water tank 700 in the front and rear direction.

In addition, a water level detection device 750 may be provided on the cover front portion. The water level detection device 750 is for detecting the water level of the water tank 700 and may include a capacitive sensor. In addition, the water level detection device 750 may be formed to protrude forward, and may be configured to be in close contact with the circumferential surface of the water tank 700 in a state where the water tank 700 is introduced. When the water level of the water tank 700 is equal to or lower than the set water level by the water level detection device 750, the controller 190 can output that there is no water in the water tank 700 through the display assembly 800 so that the user can fill the water tank 700 with water.

Hereinafter, the water level detection device 750 will be described in more detail with reference to the drawings.

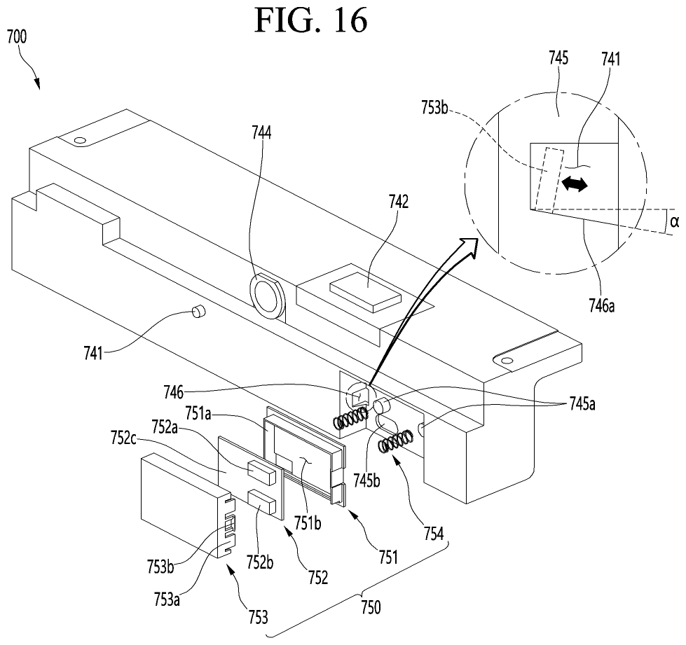

FIG. 16 is an exploded perspective view illustrating a pump cover constituting the water supply module, and FIG. 17 is a cross-sectional view taken along line 17-17′ of FIG. 13.

As illustrated in the drawing, a detection device accommodation portion 745 in which the water level detection device 750 is mounted may be formed on the cover front portion 740a. The detection device accommodation portion 745 is formed to have a size corresponding to that of the water level detection device 750 and may be recessed rearward.

An electric wire hole 745b through which an electric wire connected to the water level detection device 750 is introduced or withdrawn may be formed inside the detection device accommodation portion 745. In addition, a spring boss 745a may be formed inside the detection device accommodation portion 745 facing the detection device accommodation portion 745. A spring 754 may be mounted on the spring boss 745a.

The spring 754 may support the detection case 751 to be described below. Accordingly, in a state where the water level detection device 750 is mounted in the detection device accommodation portion 745, the water level detection device 750 may protrude further than the cover front portion 740a and can be maintained a state of being in contact with the circumferential surface of the water tank 700.

The water level detection device 750 may include a detection sensor 752 for detecting the water level, a detection case 751 for accommodating the detection sensor 752, and the spring 754 for elastically supporting the detection case 751.

The detection sensor 752 may be configured as a capacitive sensor, and thus can detect the water level inside the water tank 700 by being in contact with the circumferential surface of the water tank 700, more specifically, the circumferential surface of the tank body 710 without being in direct contact with the water inside the water tank 700.

In detail, a plurality of detection sensors 752 may be provided, and may be respectively disposed at heights corresponding to the low water level and the full water level H2 of the water tank 700 and corresponding heights. The detection sensor 752 may include an upper sensor 752a provided above to detect the full water level H2, and a lower sensor 752b provided below to detect the low water level H1. The low water level H1 may be a water level that requires additional water supply in the water tank 700 due to insufficient moisture. For example, the low water level H1 may be a water level at which the water tank 700 is not completely emptied, but at which an amount that can be supplied 1-2 times remains. In addition, the full water level H2 may be a water level of a sufficient amount of water that can be supplied to the bed 300 for a set number of times or more. The full water level H2 may be a height when the water tank 700 is filled with more than a set amount of water. Of course, two or more detection sensors may be provided to detect and guide the water level of the water tank 700 in more detail step by step. For example, the same detection sensor may be further provided between the upper sensor 752a and the lower sensor 752b and in this case, since the intermediate water level between the full water level and the low water level is sensed, the detection sensor may be called an intermediate sensor.

Accordingly, when the water inside the water tank 700 reaches the corresponding water level, the upper sensor 752a or the lower sensor 752b may detect that the water level of the water tank 700 is at the low water level or the full water level due to a change in current, and the controller 190 may display it on the display assembly 800 or the user's portable device to guide the additional water supply in a timely manner.

The detection case 751 may have a case edge 751a formed along the circumference thereof, and a sensor accommodation space 751b capable of accommodating the detection sensor 752 therein may be formed. The sensor accommodation space 751b may be opened forward, and may have a structure capable of accommodating the entire substrate on which the plurality of detection sensors 752 are mounted. In addition, an opening is formed at one side of the detection case 751 to allow the electric wire connected to the substrate 752c to be introduced or withdrawn.

In addition, the detection case 751 may be formed in a shape corresponding to the detection device accommodation portion 745. In addition, the rear surface of the detection case 751 may be supported by the spring 754 so that the detection sensor 752 is always pressed toward the circumferential surface of the water tank 700. In addition, an additional structure to which the spring 754 may be fixed may be further provided on the rear surface of the detection case 751.

Meanwhile, the position of the spring 754 may be located at the center of the detection case 751 in the vertical direction and may be disposed on both sides at the same height in the left and right direction. In other words, the position of the spring 754 may be the same height as the guide protrusion 753b to be described below. Accordingly, when a force is applied from the front of the detection cover 753 to the detection cover 753 in an eccentric direction, the detection cover 753 may be configured to incline naturally.

The water level detection device 750 may further include a detection cover 753. The detection cover 753 may shield the open front surface of the detection case 751 and may form an outer appearance of the water level detection device 750 exposed to the outside of the pump cover 740. In addition, the detection cover 753 may substantially contact the circumferential surface of the water tank 700.

In detail, the detection cover 753 may be formed in a shape corresponding to the detection case 751, and the detection case 751 may be inserted through the open rear. Accordingly, the detection sensor 752 and the detection case 751 may be disposed in the inner area of the detection cover 753.

In addition, cover coupling portions 753a may be formed on both sides of the detection cover 753 in the left and right direction. The cover coupling portion 753a may be formed at an open end portion of the detection cover 753 and may be formed in a hook shape to constrain both ends of the detection case 751. In addition, a plurality of cover coupling portions 753a may be provided in the vertical direction so that the detection cover 753 and the detection case 751 are firmly coupled.

In other words, the detection cover 753 and the detection case 751 may be coupled to each other by the cover coupling portion 753a. In addition, in a state where the detection cover 753 and the detection case 751 are coupled, the front surface of the detection sensor 752 may be fixed in a state of being in close contact with the detection cover 753. Accordingly, the detection sensor 752 may maintain a state of being adjacent to the water tank 700.

Meanwhile, guide protrusions 753b may be further formed on both side surfaces of the detection cover 753. The guide protrusion 753b may be positioned between the cover coupling portions 753a disposed vertically and may be positioned at the center of the detection cover 753 in the vertical direction.

The guide protrusion 753b may protrude outward and may be inserted into the guide grooves 746 formed on both inner sides of the detection device accommodation portion 745 in the left and right direction. Accordingly, when the detection cover 753 moves in the front and rear direction, the guide protrusion 753b may move along the guide groove 746. In addition, the guide protrusion 753b is inserted into the guide groove 746 to limit the distance at which the detection cover 753 protrudes from the detection device accommodation portion 745, and it is possible to prevent the detection cover 753 from being separated from the detection device accommodation portion 745.

The guide groove 746 may be formed to have a width equal to or greater than a width of the guide protrusion 753b in the upper and lower direction. In addition, the lower end 746a of the guide groove 746 may have an inclination by a set angle α with respect to the bottom surface of the water tank 700. In this case, the lower end of the guide groove 746 may be lowered from the front to the rear. In addition, the front end of the guide groove 746 may correspond to the width of the guide protrusion 753b in the vertical direction. Of course, not only the lower end of the guide groove, but also the entire guide groove 746 may be formed to be inclined at a set angle α.

Meanwhile, the tank body 710 with which the detection cover 753 is in contact may have a flat circumferential surface. In addition, the tank body 710 may be injection-molded of a plastic material, and in order to facilitate the molding of the tank body 710 in a downwardly recessed form, the circumferential surface of the tank body 710 can be formed to have an inclination. In other words, the circumferential surface of the tank body 710 may be formed to be inclined by a set angle α with respect to a surface perpendicular to the bottom surface of the water tank 700.

Accordingly, the inclination of the circumferential surface of the tank body 710 and the inclination of the lower end of the guide groove may have the same set angle α. Accordingly, while the water tank 700 is introduced, the circumferential surface of the tank body 710 and the detection cover 753 can be kept in close contact with each other.

Hereinafter, a state of being in contact with the water level detection device 750 when the water tank 700 is introduced or withdrawn will be described in more detail step by step with reference to the drawings.

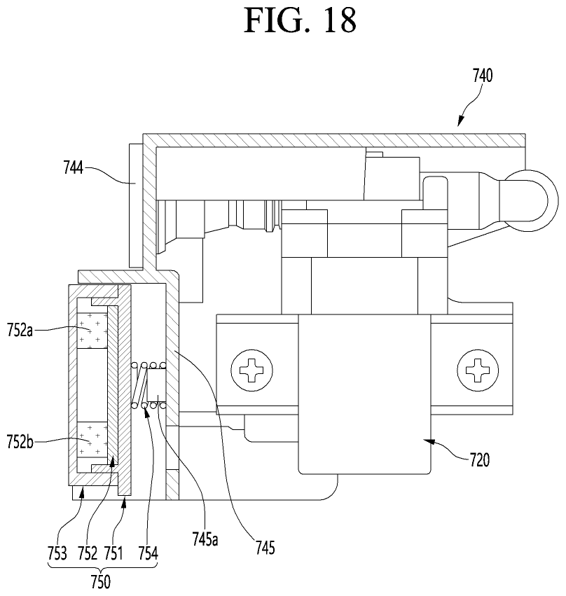

FIG. 18 is a cross-sectional view illustrating a state of the water level detection device in a state where the water tank is withdrawn.

As illustrated in the drawing, in a state where the water tank 700 is completely withdrawn or the water tank 700 is withdrawn by a set distance, the water tank 700 does not come into contact with the water level detection device 750 and separated completely from the water level detection device 750.

In such a state, a force in the compression direction is not applied to the spring 754 so that the spring 754 may be in the most tensioned state. In addition, the detection cover 753 protrudes more than the cover front portion 740a in the most protruded state. In addition, although not illustrated in detail, the guide protrusion 753b may be in a state of being positioned at the front end of the guide groove 746.

When the water tank 700 is separated from the water level detection device 750, the detection sensor 752 may be in a state where the water level is not detected.

A user may open the tank cover 713 in a state where the water tank 700 is withdrawn and fill the water tank 700 with water. In addition, the water tank 700 may be introduced while the tank cover 713 is filled with water so that water can be supplied to the bed 300.

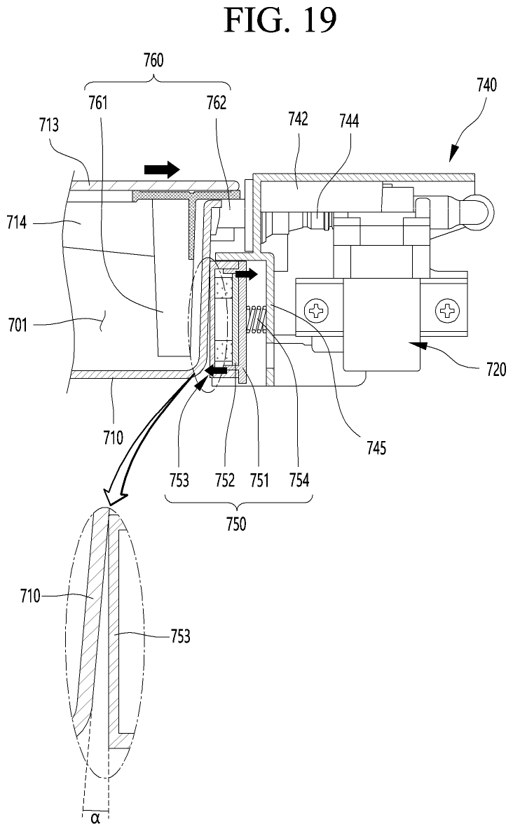

FIG. 19 is a cross-sectional view illustrating a state of the water level detection device in a state where the water tank and the water level detection device start to come into contact.

As illustrated, the user can introduce the water tank 700 in a state where the water tank 700 is filled with water. When the water tank 700 is introduced by a set distance in the course of being introduced, the circumferential surface of the water tank 700, that is, the circumferential surface of the tank body 710 may be in contact with the water level detection device 750.

In detail, the water tank 700 may be moved rearward so that the circumferential surface of the tank body 710 may be in contact with the detection cover 753. Looking at the moment when the circumferential surface of the tank body 710 and the detection cover 753 come into contact with each other, as illustrated, the inclined outer surface of the tank body 710 first can be in contact with the upper end of the detection cover 753.

In this state, when the water tank 700 is moved further rearward, a force is applied to the upper portion of the detection cover 753. The detection cover 753 is rotated as a force is applied so as to be eccentric upward with respect to the guide protrusion 753b. In other words, the upper end of the detection cover 753 is rotated toward the rear, and the lower end of the detection cover 753 is rotated toward the front.

At this time, due to the tilting of the detection cover 753, the front surface of the detection cover 753 may be completely in close contact with the outer surface of the tank body 710. In addition, when the water tank 700 is moved further rearward, the detection cover 753 may be moved rearward in a state of being in close contact with the tank body 710.

When the detection cover 753 moves backward, the guide protrusion 753b moves along the inclined guide groove. Accordingly, the detection cover 753 may be moved backward while maintaining the inclined state by an angle corresponding to the inclination of the circumferential surface of the water tank 700. In addition, the spring 754 may be compressed by the rearward movement of the detection cover 753.

Meanwhile, when the water tank 700 is introduced, the moving rail 731 is moved rearward to operate the closing module 733, and the water tank 700 is completely moved rearward by the closing module 733.

In other words, even if the user does not directly push the water tank 700 completely rearward, the water tank 700 can be completely introduced backward by the closing module 733, and the connection pipe 760 and the pipe connection portions 744 are connected to each other, the switch 741 is pressed, and the water level detection device 750 can be in close contact with the circumferential surface of the water tank 700.

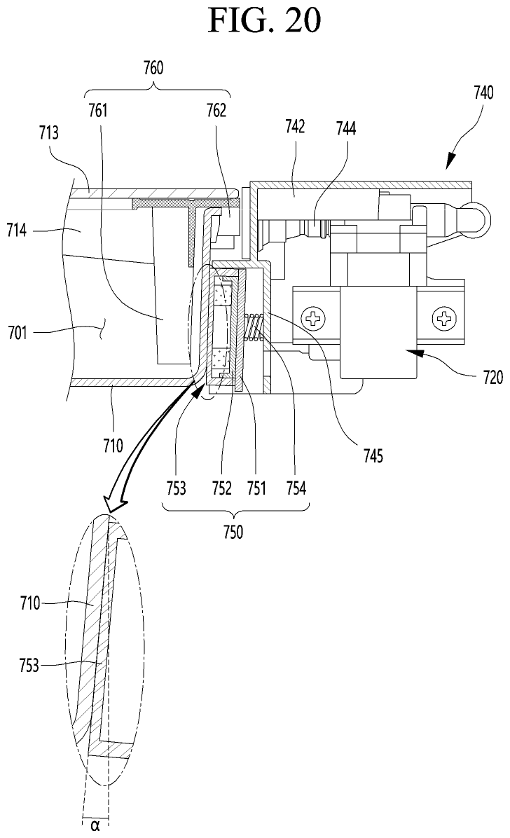

FIG. 20 is a cross-sectional view illustrating a state of the water level detection device in a state where the water tank is completely introduced.

As illustrated, in a state where the water tank 700 is fully introduced, the water level detection device 750 may be in close contact with the circumferential surface of the water tank 700.

At this time, the detection cover 753 may be in an inclined state rotated at the same inclination as that of the outer surface of the tank body 710 in a state of being in surface contact with the circumferential surface of the tank body 710. In addition, in this case, the spring 754 may keep the detection cover 753 in full contact with the circumferential surface of the water tank 700 in the maximum compression state.

Accordingly, in this state, the water level of the water tank 700 may be accurately detected through the detection sensor 752.

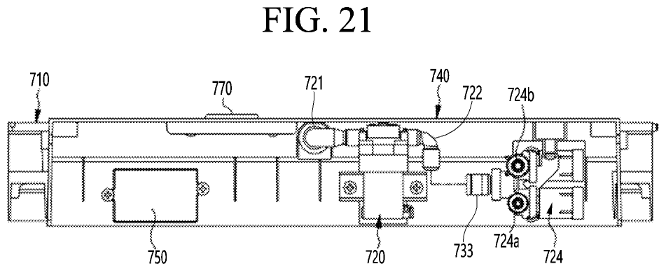

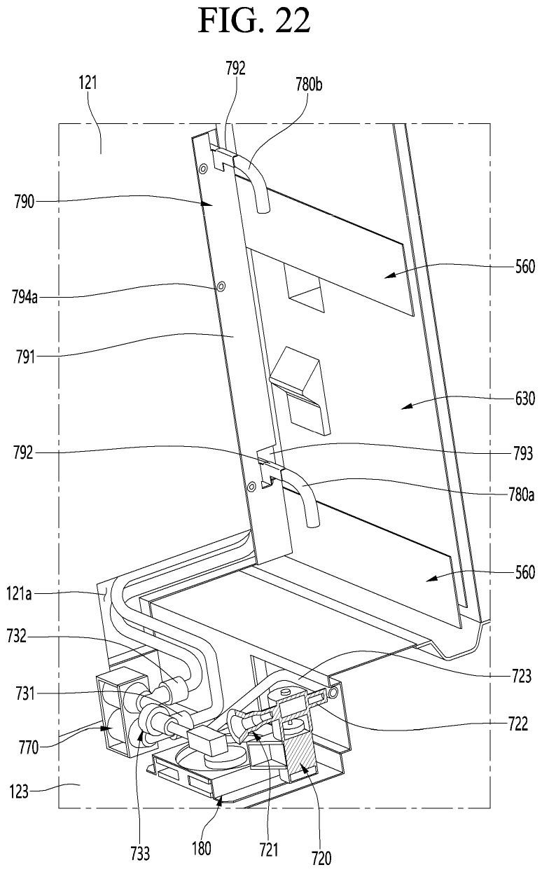

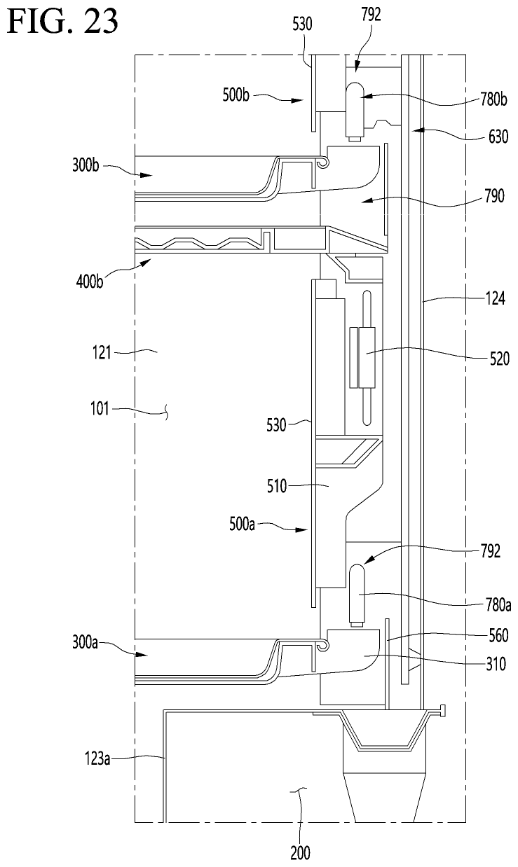

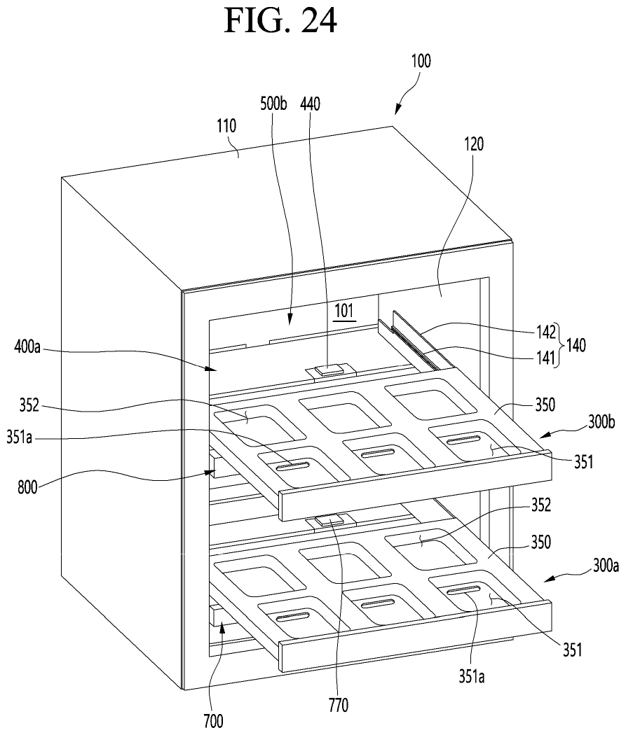

FIG. 21 is a rear view illustrating the pump cover, FIG. 22 is a perspective view illustrating a state where the water supply flow path is fixed, and FIG. 23 is an enlarged view illustrating part “B” of FIG. 5.

As illustrated in the drawing, the pump cover 740 may include a pipe connection portion 721, a water pump 720, and a water supply valve 724.

In addition, a pipe connection portion 721 and a water pump 720 may be connected to each other inside the pump cover 740, and the water pump 720 may be connected to a water supply valve 724 by a pipe 723. In addition, a water supply flow path 780 for supplying water to the bed 300 may be connected to the output side of the water supply valve 724. In addition, components for water supply may be shielded when the pump cover 740 is mounted.

In detail, the opened front surface of the pipe connection portion connected to the connection pipe 760 may be exposed on one front side of the pump cover 740. The front surface of the pipe connection portion 721 may be formed at a position corresponding to the rear end of the connection pipe 760. Accordingly, when the water tank 700 is introduced, the rear end of the connection pipe 760 may be inserted into the pipe connection portion 721.

In addition, a water pump 720 may be provided on the rear surface of the pump cover 740. The water pump 720 forces the water of the water tank 700 to flow toward the bed 300, and the inlet of the water pump 720 is connected to the pipe connection portion 721 and the outlet 722 thereof may be connected to a pipe 723 connected to the water supply valve 724.

The water supply valve 724 is opened when the water pump 720 is driven so that water can be supplied toward the bed 300. A plurality of water supply valves 724 may be provided according to the number of beds 300, and one water supply valve 724 may be branched to supply water to each of the plurality of beds 300.

In this embodiment, the input side 733 of the water supply valve 724 is connected to the outlet 722 of the water pump 720 by the pipe 723, and the output side of the water supply valve 724 is branched so that the upper fitting 724b and a lower fitting 724a may be formed. In addition, an upper water supply pipe 780b and a lower water supply pipe 780a are connected to the upper fitting 724b and the lower fitting 724a, respectively, so that a structure through which independent water supply to the upper bed 300b and the lower bed 300a is possible may be provided. Accordingly, different water supply environments may be created in the upper bed 300b and the lower bed 300a, and an appropriate amount of water may be supplied to each of the upper bed 300b and the lower bed 300a.

Accordingly, the connection pipe 760 and the pipe connection portion 721, the water pump 720, the water supply valve 724, and the water supply pipe are sequentially connected, and the water in the water tank 700 by the operation of the water pump 720 may be supplied to the bed 300 through the water pump 720 and the water supply valve 724.

In addition, a discharge fan 180 may be provided under the pump cover 740. The discharge fan 180 allows the air in the cultivation space 101 to be discharged to the outside via the machine room 200. The discharge fan 180 can be shielded by the pump cover 740 to prevent exposure to the outside and is provided on the lower surface of the cultivation space 101 adjacent to the machine room 200 so that exhaust can be made more smoothly.

Meanwhile, a recessed pipe guide 121a may be formed on a side surface of the inner case 120. The pipe guide portion 121a may be formed to be recessed outwardly so that the water supply flow path 780 can be accommodated therein.

The guide cover 790 may be formed to shield the pipe guide 121a. The guide cover 790 may be formed to shield the entire pipe guide 121a or may be formed to shield only a portion of the entire pipe guide 121a exposed to the outside.

Meanwhile, a cutout 793 may be formed in the guide cover 790. The cutout 793 may be formed above the water supply portion 310 formed in the upper bed 300b and the lower bed 300a. The cutout 793 may be formed at one end of the guide cover 790. In addition, a water supply pipe mount 792 for fixing the water supply pipes 780a and 780b may be formed inside the cutout 793.

Meanwhile, the water supply pipe mount 792 is disposed above and below the upper bed 300b and the lower bed 300a, respectively, and the upper water supply pipe 780b and the lower water supply pipe 780a are mounted on each of the water supply pipe mount 792 so that water can be independently supplied to the upper bed 300b and the lower bed 300a.

The upper water supply pipe 780b and the lower water supply pipe 780a are positioned at the corners of the rear surface and the side surface of the cultivation space 101. Accordingly, the upper water supply pipe 780b and the lower water supply pipe 780a may extend upward in a corner area where the rear plate 124 and the side plate 121 are adjacent to each other. In other words, the water supply pipes 780a and 780b are guided along the inner side of the cultivation space 101 to facilitate disposition, and extend upward along the corner area of the cultivation space 101 to minimize interference with internal components.

In particular, the upper water supply pipe 780b and the lower water supply pipe 780a are disposed at a position apart from the side of the evaporator so as not to interfere with the evaporator 630 mounted on the front surface of the rear plate 124, and thus prevents the water flowing along the water supply pipes 780a and 780br from freezing or excessively lowering the temperature by the cold air of the evaporator. In addition, the evaporator 630 has a structure that prevents interference with the internal components of the cabinet 100 and facilitates disposition operation.

The upper water supply pipe 780b and the lower water supply pipe 780a are configured to extend inside the cultivation space 101 from above the bed 300 so that the upper water supply pipe 780b and the lower water supply pipe 780a do not interfere at all even when the bed 300 is introduced or withdrawn. In addition, in a state where the bed 300 is fully introduced, the outlets of the upper water supply pipe 780b and the lower water supply pipe 780a are positioned in the center portion of the water supply portion 310, so that water supply to the upper bed 300b and the lower bed 300a can be smoothly performed.

In addition, the water supply portion 310 may be located further back than the front area of the blower assembly 500, and in particular, portions of the upper water supply pipe 780b and the lower water supply pipe 780a protruding into the cultivation space 101 may also be located further rearward. In particular, the protruding portions of the upper water supply pipe 780b and the lower water supply pipe 780a may be located in the space below the fan guide 510, and are located behind the blower cover 530 to be capable of being covered without being interfered by the blower assembly 500.

Due to this structure, when the user opens the door 130 and looks at the cultivation space 101, the end portion of the upper water supply pipe 780b and the end portion of the lower water supply pipe 780a, which supply water to the upper bed 300b and the lower bed 300a can be prevented from being exposed to the outside. Accordingly, the inside of the cultivation space 101 can be seen more clearly, and a cleaner image can be provided.

Hereinafter, the structure of the bed 300 will be described in more detail with reference to the drawings. Even if a plurality of the beds 300 are provided, only one bed 300 will be described because a plurality of the beds 300 all have the same structure except for a different mounting position.

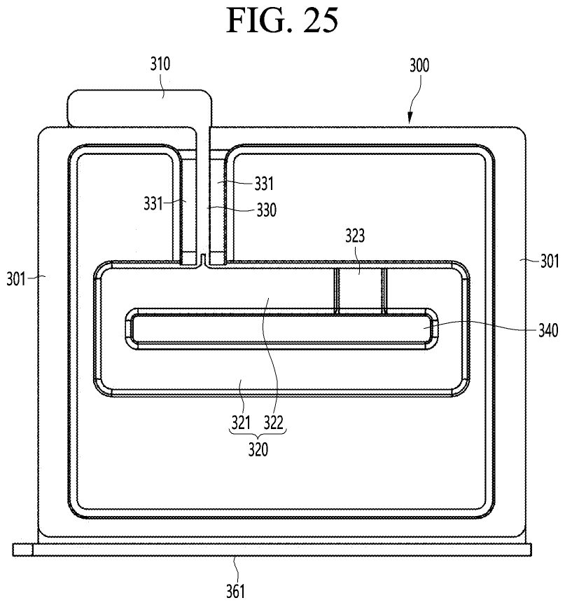

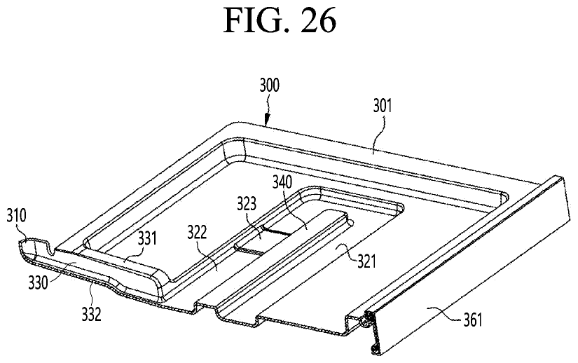

FIG. 24 is a perspective view illustrating a state where the bed of the apparatus for cultivating plants is withdrawn, FIG. 25 is a plan view illustrating the bed, and FIG. 26 is a cut-away perspective view illustrating the bed.

As illustrated in the drawings, the bed 300 may be formed in a rectangular plate shape that partitions the cultivation space 101, and can be mounted to be introduced into/withdrawn from the cultivation space by the bed rail device 140 mounted on both sides of the cultivation space 101.

The bed rail device 140 may include a slidably extending bed rail 142 and a rail bracket 141 capable of fixing the bed rail 142 to both sides of the cultivation space 101. The bed rail 142 may have a structure extending in multiple stages and may connect between both side surfaces of the bed 300 in the left and right direction and the rail bracket 141.

The bed 300 may form a structure which is formed in a rectangular shape as a whole to provide a space in which a plurality of pods 10 are disposed and in which water supplied can be stored. In addition, the bed 300 may be formed of a plastic material to form a structure for guiding the flow of supplied water.

A bed flange 301 extending outwardly is formed around the bed 300. A bed tray 350 to be described below may be seated on the bed flange 301. In addition, the inner area of the bed flange 301 becomes an area in which the pod 10 can be disposed.

A recessed portion 302 is formed inside the bed flange 301, and the bed tray 350 may be seated in the recessed portion 302. The recessed portion 302 may be formed to accommodate the entire plurality of pod seating portions 352 formed in the bed tray 350. In addition, when the bed tray 350 is mounted, the upper surface of the bed 300 and the lower surface of the bed tray 350 may be in contact with each other and overlapped.

A water supply portion 310 may be formed at the rear end of the bed 300. The water supply portion 310 may be positioned at one end of both sides in the left and right direction and may be formed to protrude rearward from the rear end of the bed 300. In other words, the water supply portion 310 may be positioned vertically below the end portions of the water supply pipes 780a and 780b protruding from the side surface of the cultivation space 101.

The water supply portion 310 may be formed in a shape in which an upper surface is opened and a lower surface is recessed. The circumference of the water supply portion 310 protrudes to a predetermined height to prevent water supplied from the water supply pipes 780a and 780b from splashing or overflowing.

A water collection portion 320 in which water supplied through the water supply portion 310 is stored may be formed in the bed 300. In addition, a water guide 330 may be recessed between the water supply portion 310 and the water collection portion 320. In other words, the water guide 330 may connect the water supply portion 310 and the water collection portion 320, and the water supplied to the water supply portion 310 may be supplied to the water collection portion 320 along the water guide 330.

The water supply portion 310 is positioned higher than the water collection portion 320, and water from the water supply portion 310 may naturally flow into the water collection portion 320. In addition, the water guide 330 may be formed to have an inclination that gradually decreases from the water supply portion 310 toward the water collection portion 320. Accordingly, when water is supplied to the water supply portion 310, water may be naturally supplied to the water collection portion 320 along the water guide 330.

Meanwhile, guide walls 331 may be formed on both sides of the water guide 330 to form the water guide 330. The guide wall 331 may extend from the water supply portion 310 to the water collection portion 320, and a pair of the guide wall may be spaced apart from each other to form both side surfaces of the water guide 330. In addition, the guide wall 331 may be formed to have a height corresponding to the height of the bed flange 301 to support the bed tray 350 from below.

The water guided from the water supply portion 310 to the water collection portion 320 by the water guide 330 may be directed toward the water collection portion 320 without overflowing to the outside. In particular, the bottom surface of the water guide 330 may be inclined at a height higher than that of the water collection portion 320 by the guide wall 331 extending upward. In addition, even in a situation where the height difference between the water supply portion 310 and the water collection portion 320 is not large, the water supplied to the water supply portion 310 does not overflow and can be directed to the water collection portion 320, and can provide a path with sufficient space to be guided smoothly. In other words, it provides a structure in which the water of the water supply portion 310 can be stably supplied without excessively deepening the recessed depth of the water collection portion 320, thereby increase in the thickness of the bed 300 in the upper and lower direction can be prevented, and thereby the bed 300 can have a slim structure.

In addition, the guide wall 331 and the water guide 330 may extend between a pair of pod seating portions 352 recessed in the bed tray 350. Accordingly, the guide wall 331 can be prevented from interfering when the bed tray 350 is seated, and a space for water supply can be secured through the space between the adjacent pod seating portions 352.

Meanwhile, in the central area of the bed 300, a water collection portion 320 for storing water supplied to the pod 10 may be recessed. The water collection portion 320 is more recessed than the bottom surface of the recessed portion 302 formed around the water collection portion 320 so that water supplied to the water supply portion 310 is existed only in the water collection portion 320 area in a state of being stored.

In detail, the water collection portion 320 is positioned in the center of the bed 300 and may extend from the left end to the right end of the bed 300. In addition, the water collection portion 320 may be formed to have a predetermined width in the front and rear direction so that all of the seating portion openings 351a formed in the bed tray 350 can be accommodated.

In addition, a bed protrusion 340 protruding upward may be formed in the central portion of the bed 300. A height of the bed protrusion 340 may be the same as or higher than that of the recessed portion 302. The bed protrusion 340 may be positioned in the center of the water collection portion 320. Accordingly, the water collection portion 320 may have a closed loop shape, and water flowing thereinto through the water guide 330 may flow along the inside of the closed loop shape of water collection portion 320. In addition, in the area of the water collection portion 320, a portion positioned in front of the bed protrusion 340 may be referred to as a front water collection portion 321, and a portion positioned at the rear of the bed protrusion 340 may be referred to as a rear side a water collection portion 322.

In addition, a distance between the outer end of the water collection portion 320 and the bed protrusion 340 may be greater than the width of the seating portion opening 351a in the front and rear direction. Accordingly, when the bed tray 350 is seated, the seating portion opening 351a may be disposed along the water collection portion 320.

The widths of the front-side water collection portion 321 and the rear-side water collection portion 322 in the front and rear direction in which the seating portion opening 351a is positioned may be the same as or slightly larger than the width of the pod seating portion 352 in the front and rear direction and thus there is a structure in which an appropriate amount of water required for water supply to the pod 10 can be effectively supplied to the pod 10. In addition, unnecessary water is prevented from remaining in the water collection portion 320 for a long time to prevent contamination of the bed 300 and to always maintain the bed in a clean state.

Meanwhile, a detection portion 323 may be formed in an inner area of the water collection portion 320. The detection portion 323 may be formed at a position corresponding to the residual water detection device 742 positioned below. Accordingly, in a state where the bed 300 is fully introduced, the residual water detection device 742 may have a structure capable of being in close contact with the detection portion 323.

In this case, the detection portion 323 may have a shape that protrudes when viewed from above and is recessed when viewed from below. Accordingly, it is possible to prevent the residual water detection device 742 from interfering with the detection portion 323 in the process of introducing and withdrawing the bed 300, thereby preventing the occurrence of an obstacle in introducing and withdrawing the bed 300.

In addition, due to the structure of the protruding detection portion 323, water supplied to the detection portion 323 does not accumulate, and it is possible to accurately determine whether additional water supply is needed to the water collection portion 320.

A bed handle 361 may be formed on the front surface of the bed 300. The bed handle 361 may have a structure in which a lower surface is recessed so that a user can hold the bed handle at the time of introduction and withdrawal of the bed 300. In addition, the front surface of the bed handle 361 may be formed of the same material as the tank handle 711 or may be formed of a material of the same texture to have a sense of unity.

Meanwhile, the bed tray 350 is seated on the upper surface of the bed 300 and may form an outer appearance of an upper surface of the bed 300. The bed tray 350 may be formed of a metal material such as stainless to keep the outer appearance neat and hygienically managed.

The bed tray 350 is formed in a size capable of shielding the upper surface of the bed 300 and may be formed in a plate shape. Accordingly, in a state where the bed tray 350 is mounted on the bed 300, the upper surface of the bed 300 is formed.

In addition, a plurality of pod seating portions 352 on which the pods 10 are seated may be formed in the bed tray 350. The pod seating portion 352 is recessed in a shape corresponding to the pod 10 so that the pod 10 can be seated, and a plurality of pod seating portions 352 may be sequentially disposed. Accordingly, a plurality of the pods 10 may be disposed on the bed tray 350.

A plurality of the pod seating portions 352 may be disposed in the front half portion and the rear half portion based on the center and may be formed in the same size. In addition, a seating portion opening 351a may be formed in the pod seating portion 352. The seating portion opening 351a allows the pod protrusion 16 protruding from the lower surface of the pod 10 to pass through, and allows the pod protrusion 16 to be in contact with the water inside the water collection portion 320.

The seating portion opening 351a may be formed for each of the pod seating portions 352. In addition, the seating portion openings 351a respectively formed in the plurality of pod seating portions 352 may be disposed along an area corresponding to the water collection portion 320.

In detail, when the bed tray 350 is seated on the bed 300, the seating portion opening 351a is positioned on the water collection portion 320 so that water stored in the water collection portion 320 can be supplied to the pod 10 through the seating portion opening 351a.

In this embodiment, the water collection portion 320 is disposed in the horizontal direction in the center of the bed 300, so that the seating portion openings 351a may be also formed in a position close to the center side of the bed tray 350 to be positioned on the upper side corresponding to the inside of the water collection portion 320. In more detail, all of the seating portion openings 351a formed in the pod seating portion 352 disposed in front of the bed 300 are positioned adjacent to the rear end of the pod seating portion 352, and all the seating portion openings 351a formed in the pod seating portion 352 disposed at the rear of the bed 300 may be positioned adjacent to the front end of the pod seating portion 352. In other words, the seating portion openings 351a may be continuously disposed along the inner area of the water collection portion 320.

Hereinafter, a structure in which the water of the water collection portion 320 is supplied to the pod 10 will be described in more detail with reference to the drawings.

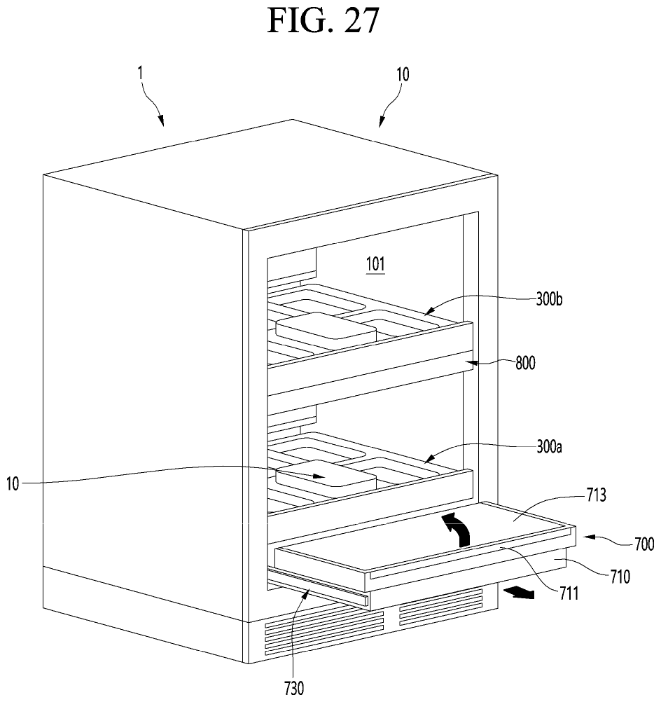

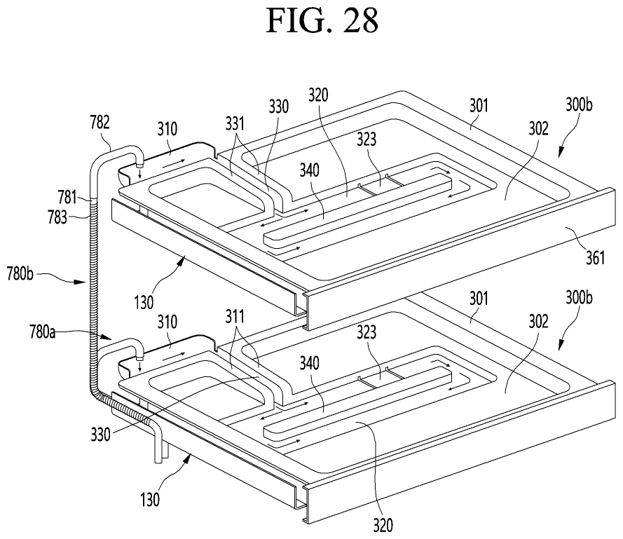

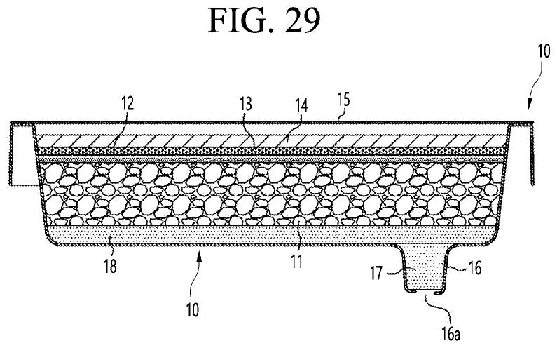

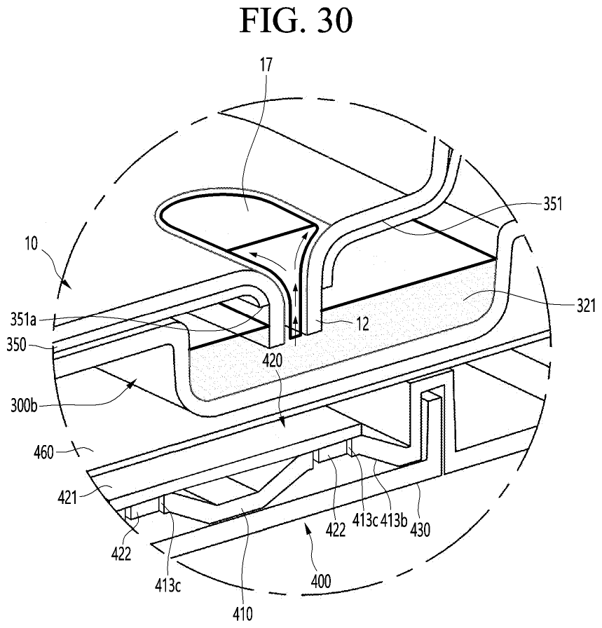

FIG. 27 is a perspective view illustrating a state where the water tank is withdrawn, FIG. 28 is a perspective view illustrating a water supply state of the bed, FIG. 29 is a cross-sectional view illustrating a pod seated on the apparatus for cultivating plants, and FIG. 30 is an enlarged view illustrating part “C” of FIG. 4.

As illustrated, the pod 10 may be configured by types of plants that can be cultivated with the apparatus for cultivating plants 1. Of course, each of the pods 10 composed of several types of plants may all have the same size and may have a size set to be accommodated in the pod seating portion 352. Accordingly, the user can select the pod 10 of the plant desired to be cultivated and seat the pod at a desired position on the bed 300 to start cultivation.

In detail, the pod 10 may have an outer shape formed by a container opened upward. Top soil 11 containing a nutrient solution material (not illustrated) is filled in the pod 10. The nutrient solution material is a material containing nutrients supplied to plants to grow better. Such a nutrient solution material may be provided in the form of a water-soluble capsule that is gradually dissolved in water and may be configured to be contained in the feed water while gradually dissolving each time the feed water is supplied.

A seed paper 12 is provided on the upper surface of the top soil 11. The seed paper 12 may be composed of a sheet in which seeds are disposed to have a predetermined arrangement. When feed water is supplied in a state where the seed paper 12 is seated on the upper surface of the top soil 11, the seed paper 12 melts and disappears, and the seeds remain in the top soil 11.

A brick 13 is provided on the upper surface of the seed paper 12. The brick 13 is configured to adjust the moisture and humidity of the soil and prevent the formation of mold, and is made by processing inorganic ore such as vermiculite into a powder state and then pressing the powder state of the inorganic ore.

In addition, the upper surface of the pod 10 is covered with a protective paper 15 to protect the inside thereof. In particular, a packing member 14 is further provided between the upper surface of the brick 13 and the protective paper 15 to protect the brick 13 from the external environment. In addition, the type of plant to be cultivated may be printed on the protective paper 15 to provide information about the pod to the user.

Meanwhile, a protrusion 16 protruding downward is formed on the bottom surface of the pod 10, and a water-through hole 16a may be formed on the bottom surface of the protrusion 16. The protrusion 16 may be formed in a pipe structure with an empty inside while being opened up and down.

A first absorbing member 17 for absorbing water supplied to the beds 300a and 300b may be provided in the protrusion 16, and a second absorbing member 18 having a flat plate shape may be provided between the first absorbing member 17 and the top soil. The second absorbing member 18 functions to evenly supply the feed water absorbed by the first absorbing member 17 to the entire area of the top soil 11.

As illustrated in FIG. 30, when the pod 10 is seated on the pod seating portion 352, the pod protrusion 16 may protrude downward through the seating portion opening 351a. At this time, the pod protrusion 16 is positioned inside the water collection portion 320, that is, the front water collection portion 321.

When water is supplied to the inside of the water collection portion 320 in this state, the pod protrusion 16 can come into contact with the water inside the water collection portion 320. In addition, the water of the water collection portion 320 may flow thereinto through the water-through hole 16a, and along the first absorbing member 17 and the second absorbing member 18 inside the pod protrusion 16, water may be absorbed. In addition, the water absorbed through the first absorbing member 17 and the second absorbing member 18 may be uniformly supplied to the top soil of the pod 10.

Hereinafter, an operation of the apparatus for cultivating plants 1 according to an embodiment of the present disclosure having the above structure will be described.

In order to use the apparatus for cultivating plants 1, the user withdraws the water tank 700 and fills the water tank 700 with water. At this time, when the water tank 700 contains enough water, the display assembly 800 may indicate that the water is sufficient or that the water level is full, and when the water tank 700 is insufficient in water, water shortage or low water level may be indicated through the display assembly 800.

A user fills the water tank 700 with a sufficient amount of water in order to allow the apparatus for cultivating plants 1 to operate smoothly and plants can be effectively cultivated.

Then, the user selects a plant desired to be cultivated, and after removing the protective paper of the corresponding pod, the plant is seated on the bed. When the pod 10 is seated on the bed 300, a predetermined amount of water stored in the water tank 700 is supplied to the bed 300.

When the controller 190 generates a water supply signal to the bed 300, water is supplied to the bed 300 by the operation of the pump 720 and the operation of the water supply valve 724. The water supplied to the water supply part 310 through the water supply pipes 780a and 780b flows toward the water collection portion 320 and may be accommodated in the water collection portion 320. In addition, the pod 10 seated on the bed 300 absorbs the water filled in the water collection portion 320.

At this time, the amount of water supplied is a set amount and may be slightly less than the amount to be sufficiently supplied to the pod 10. Accordingly, the supplied water may be absorbed from the water collection portion 320 to the pod 10, and when a predetermined time elapses, the supplied water is completely absorbed so that no water remains in the water collection portion 320.

When the residual water detection device 742 detects that there is no water in the water collection portion 320, the residual water detection device 742 supplies again the predetermined amount of water and again detects that there is no water left in the water collection portion 320, the controller 90 detects the time at this time and thus determines whether the set time has elapsed.

While repeating this process, the predetermined amount of water is continuously supplied and the time taken to be absorbed by the pod 10 is measured. If the time for which no water remains in the water collection portion 320 after water supply has elapsed for a set time, it is determined that sufficient water has been supplied and the water supply is stopped for a certain period of time. In addition, when the conditions for supplying water again are satisfied, water-supply is started again.

Accordingly, the water collection portion 320 does not maintain a state of being accommodated for a long time, and the amount of water required for plant growth can be supplied in a timely manner. In addition, nutrients necessary for plant growth are supplied in the form of a nutrient solution contained in the pod 10 so that the plants inside the pod 10 can grow effectively.

Meanwhile, light is irradiated toward the plant growing in the bed 300 by the operation of the light assembly 400. The light assembly 400 may be turned on and off at an appropriate time period according to the growth state and environment of the plant. In particular, by turning the light assembly 400 on and off according to the actual amount of sunlight according to the season, it is possible to provide an environment similar to that in which plants inside the apparatus for cultivating plants 1 grow in an external natural environment.

Plants in the bed 300 perform photosynthesis by the light provided by the light assembly 400, and carbon dioxide necessary for this process may be supplied through the air flowing into the cultivation space.

Meanwhile, in a case where the temperature inside the cultivation space 101 is too low, the heater is driven, and in a case where the temperature inside the cultivation space 101 is too high, the refrigeration cycle is driven and the evaporator 630 performs a cooling action.

Air heated or cooled by the heater or evaporator 630 is discharged forward through the blower assembly 500. At this time, air flows from the rear end of the light assembly 400 to the front, and the lower surface of the light assembly 400 is cooled during the air flow process.

Then, the air moved forward is moved downward and then flows from the front end of the bed 300 to the rear end of the bed 300. Stems and leaves of plants grown in the bed 300 are shaken by the flow of air flowing from the upper surface of the bed 300, so that the state of the cultivated plants can be remarkably improved.

The air flowing into the rear end of the bed 300 passes through again the space in which the evaporator 630 and the heater are disposed and may be discharged toward the light assembly 400 by the blower fan 520.

The air flowing by the operation of the blower fan 520 circulates inside the cultivation space 101, and continuously air-cools the light assembly 400 during the circulation process and facilitates the growth of food in the bed 300.

In addition, by continuously and uniformly heating and cooling the inside of the cultivation space 101 through a repeated air circulation process, the entire cultivation space 101 may maintain a set temperature.

The user can check the state inside the cultivation space 101 through the door 130, and when the plants in the cultivation space 101 reach a harvestable state, the plants are harvested. In addition, if plant management is necessary before harvest, an appropriate operation is performed, and unnecessary crops may be discarded or the harvested pod 10 may be removed.

For example, when the water in the water tank 700 runs out and the water level detection device 750 detects a low water level during the cultivation of the plant, the low water level is displayed on the display assembly 800 or the state of the low water level is displayed on the user's portable device.

After confirming this, the user may withdraw the water tank 700 and refill the water tank 700 with water, and the apparatus for cultivating plants 1 may continuously perform an operation for normal cultivation activities.

Meanwhile, the apparatus for cultivating plants 1 according to an embodiment of the present disclosure forms a space in which the cabinet 100 is insulated, a door 130 for opening and closing the inner space is provided, and since the components of the refrigeration cycle for temperature adjustment of the inner space are provided, the apparatus for cultivating plants 1 may be viewed as a kind of refrigerator. In other words, the main components of the apparatus for cultivating plants may be substantially the same as those of the refrigerator.

Accordingly, another embodiment of the present disclosure may be applied to a refrigerator including the cabinet 100, the door 130, components constituting the refrigeration cycle, and the water supply apparatus and related components.

### INDUSTRIAL APPLICABILITY

The water supply apparatus inside the cabinet according to the embodiment of the present disclosure has high industrial applicability because ease of use is improved.

1-15. (canceled)

16. A water supply apparatus disposed in a cabinet, the cabinet including an outer case that defines an outer appearance of the cabinet, an inner case that defines a first space, and an insulating material that is disposed between the inner case and the outer case, the water supply apparatus comprising:
a water tank comprising a tank body configured to store water and a tank cover configured to open and close the tank body;
a tank rail disposed in the inner case and configured to guide the water tank to be inserted into and withdrawn from the first space; and
a water level detector disposed in the first space and configured to be in contact with the tank body based on the water tank being inserted into the first space, the water level detector being configured to detect a water level of water in the tank body.

17. The water supply apparatus of claim 16, wherein the water level detector comprises:
a detection sensor configured to detect the water level in the water tank;
a detection case that accommodates the detection sensor; and
a spring configured to support the detection case from a rear side of the detection case and to press the detection case forward toward the water tank.

18. The water supply apparatus of claim 17, wherein the detection sensor comprises:
an upper sensor configured to detect whether the water level corresponds to a full water level of the water tank; and
a lower sensor disposed below the upper sensor and configured to detect whether the water level corresponds to a low water level of the water tank less than the full water level.

19. The water supply apparatus of claim 18, wherein the water tank further comprises a connection pipe that extends toward a bottom of the tank body and is configured to discharge the water from the water tank, and
wherein the lower sensor is positioned at a height corresponding to a lower end of the connection pipe.

20. The water supply apparatus of claim 18, wherein the detection sensor is one of a plurality of detection sensors that are disposed at positions corresponding to a plurality of water levels between the full water level and the low water level.

21. The water supply apparatus of claim 17, wherein the detection sensor comprises a capacitive sensor.

22. The water supply apparatus of claim 17, wherein the detection case defines an open front surface that faces the detection sensor accommodated in the detection case, and
wherein the water level detector further comprises a detection cover that covers the open front surface of the detection case and is configured to be in contact with a rear surface of the tank body.

23. The water supply apparatus of claim 16, further comprising:
a cover that is disposed in the first space and defines a second space at a rear side of the water tank,
wherein the water level detector is disposed at the cover.

24. The water supply apparatus of claim 23, wherein the cover defines a detector accommodation portion that is recessed from a front surface of the cover and accommodates the water level detector, the front surface of the cover facing the tank body, and
wherein the water supply apparatus further comprises a spring disposed in the detector accommodation portion and configured to support a rear side of the water level detector, the spring being configured to press the water level detector forward to thereby bring the water level detector into contact with the tank body.

25. The water supply apparatus of claim 24, wherein the water level detector has a front surface that is configured to protrude forward relative to a front side of the cover based on the spring supporting the rear side of the water level detector.

26. The water supply apparatus of claim 24, wherein the spring is configured to support a central portion of the water level detector between an upper end of the water level detector and a lower end of the water level detector.

27. The water supply apparatus of claim 24, wherein the water level detector comprises a guide protrusion that is received in the detector accommodation portion of the cover, and
wherein the cover further defines a guide groove in the detector accommodation portion, the guide groove being configured to guide movement of the guide protrusion in a front-rear direction.

28. The water supply apparatus of claim 27, wherein the tank body has a bottom surface and a circumferential surface that extends upward from the bottom surface, the circumferential surface facing a surface of the water level detector and defining an inclination angle relative to the surface of the water level detector, and
wherein the guide groove is inclined with respect to the front-rear direction by the inclination angle.

29. The water supply apparatus of claim 23, further comprising:
a connection pipe that is connected to the water tank and configured to discharge the water from the water tank; and
a pipe connection portion that is disposed at the cover and configured to receive the connection pipe based on the water tank being inserted into the first space,
wherein the connection pipe is configured to be separated from the pipe connection portion based on the water tank being withdrawn from the first space.

30. The water supply apparatus of claim 29, further comprising a pump that is disposed at the second space and covered by the cover, the pump being connected to the pipe connection portion and configured to cause discharge of the water from the water tank.

31. The water supply apparatus of claim 29, wherein the connection pipe comprises:
a vertical pipe that extends toward a bottom surface of the tank body; and
a horizontal pipe that extends from the vertical pipe and protrudes rearward toward the cover relative to a rear surface of the tank body, the horizontal pipe being configured to be inserted into the pipe connection portion based on the water tank being inserted into the first space.

32. The water supply apparatus of claim 31, wherein the tank cover is rotatably coupled to the tank body, and
wherein the horizontal pipe is a part of the tank cover and configured to rotate together with the tank cover based on the tank cover rotating relative to the tank body.

33. The water supply apparatus of claim 30, wherein the cover comprises a tank switch configured to be in contact with the water tank, the tank switch being configured to detect an introduction of the water tank into the first space and an withdrawal of the water tank from the first space, and
wherein the pump is configured to stop an operation based on the tank switch detecting the withdrawal of the water tank from the first space.

34. An apparatus for cultivating plants, the apparatus comprising the water supply apparatus of claim 16.

35. A refrigerator comprising the water supply apparatus of claim 16.
